(19) United States
(12) Patent Application Publication
(10) Pub. No.: US 2015/0203215 A1
(43) Pub. Date: Jul. 23, 2015

(54) EARLY PERFORMANCE EVALUATION OF CONCEPTUAL FLIGHT AND SPACE VEHICLES

(71) Applicant: Eric T. FALANGAS, Fountain Valley, CA (US)

(72) Inventor: Eric T. FALANGAS, Fountain Valley, CA (US)

(21) Appl. No.: 14/157,656

(22) Filed: Jan. 17, 2014

(51) Int. Cl. B64F 5/00; G06F 17/50

(52) U.S. Cl. CPC B64F 5/00; G06F 17/5009; G06F 17/5095

(57) ABSTRACT

Simulation and analysis of conceptual flight vehicles in an early design phase is conducted in a framework for evaluating performance and control effectiveness that is captured by multiple design parameters modeling the effects of control and disturbance moments and forces acting upon a conceptual flight vehicle along a specified trajectory. Characteristics of multiple types of flight vehicle effectors are modeled as a system and adjusted in such a framework to converge to a controllable air frame configuration for conceptual flight vehicle under static design considerations prior to performing dynamic analyses and control system simulations.

### FIELD OF THE INVENTION

The present invention generally relates to a method of evaluating performance characteristics of conceptual flight vehicles. Specifically, the present invention relates to a method of analyzing control, stability, and maneuverability characteristics of conceptual flight vehicles by modeling flight vehicle performance parameters along a given trajectory to balance moments and forces acting on the flight vehicle with the moments and forces generated by flight vehicle effectors.

### BACKGROUND OF THE INVENTION

Designs of conceptual flight vehicles must meet, among many other things, controllability, stability, and maneuverability performance requirements in order to be certified for operation. However, early in the design process, a flight vehicle's ability to meet these requirements is often limited by the amount of control authority available. Thus, it is essential for designers to evaluate the control authority of candidate concepts early in the design phase. Designers normally consider numerous possible control authority configurations before stability and control system groups begin their analysis. However, there is no existing framework for conducting a sophisticated, early evaluation of static design parameters before detailed stability and control system design begins, to enable a much more efficient vehicular design process from start to finish.

In the early design phase of a conceptual flight vehicle, the purposes, mission goals, and hardware configuration of the vehicle that define the initial shape, mass properties, aerodynamic coefficients, and trajectory must be determined. Critical flight conditions must also be identified where performance is marginal or where discrete events occur. The design cycle, however, is an iterative process, and existing techniques for rapidly trimming multiple effectors, and evaluating vehicle performance in terms of control, stability, and maneuverability characteristics in a rapidly-changing trajectory environment are limited.

It is critical to evaluate such static design considerations at an early phase, since designers often wish to re-evaluate other performance factors such as for example aerodynamics, weight distribution, number and location of engines, fuel issues, etc., all of which are impacted by a shape of the vehicle. For example, later in the design process, it may become apparent that a center gravity is either too far back or too far in front, or that the effectors are too small or too large. There is also uncertainty where the engines or surfaces have the capability to provide the forces and moments required for maneuverability. Designers may also want to model by trading control authority in one direction against other directions by repositioning effectors, or trying other types of effectors in different locations, or may simply want to size the effectors or trade control authority between effectors. Designers may also want to know the consequences of losing an aero-surface actuator or thrust from one of the engines, or evaluate the effects of center-of-gravity variations. Such static performance evaluations of conceptual flight vehicle design need to be performed prior to any linear analysis, flight control system design, and time domain simulations, all of which are considerably more time consuming. Therefore, a significant need exists for a flexible, early-phase performance evaluation framework to improve the efficiency of the flight vehicle design process.

### BRIEF SUMMARY OF THE INVENTION

It is therefore one objective of the present invention to provide a system and method for rapidly and systematically evaluating a flight vehicle design early in the conceptual phase. It is another objective of the present invention to provide a framework for establishing early design-phase guidelines for taking corrective action when a conceptual flight vehicle does not meet the performance requirements.

It is yet another objective of the present invention to provide a system and method for trimming multiple types of flight vehicle effectors, such as control aero-surfaces, gimbaling engines, throttling engines, and reaction control jets, for a conceptual flight vehicle.

It is yet another objective of the present invention to provide a software tool for evaluating a flight vehicle design and trimming multiple types of flight vehicle effectors that is integrated as an option inside subsequent dynamic vehicular modeling tools.

It is a further objective of the present invention to provide a graphical framework for quickly synthesizing linear vehicle models at selected flight conditions along a trajectory as a starting point for subsequent detailed control system design, and for interactively and iteratively adjusting and constraining flight vehicle effector angles in the trimming process.

The present invention provides a framework for early evaluation of performance and control effectiveness of a conceptual flight vehicle design in a system and method that models multiple design parameters and the impact of forces acting upon a conceptual flight vehicle in a specified trajectory environment. The present invention, in one embodiment, uses graphics and diagrams to rapidly assess the overall performance and control capability of conceptual vehicle designs, and can be applied to any flight vehicle configuration that uses control surfaces, gimbaling engines, thrust varying engines, reaction control jets, or any combination of the above. The present invention improves and simplifies the evaluation of initial designs by helping the analyst decide which concepts should be rejected or pursued further by enabling a thorough and systematic analysis in different situations. This includes aerodynamic uncertainties, parameter variations, “what if” studies that help improve the design by graphically modifying some vehicle parameters and evaluating its robustness, in the static sense, to trajectory modifications, altered trimming conditions, or by introducing external disturbances. All these features lead to designs that satisfy mission requirements in adverse situations.

Early in the design phase, decisions are made regarding the location and size of the vehicle effectors such as the control surfaces, thrust vector control (TVC) and throttling engines, and reaction control jets, which determine the control authority. Consideration of these types of control power has become an important issue in modern flight vehicle design, with increasing demand for agility and use of advanced flight control systems with relaxed static stability. Excessive control authority can translate into increased weight and drag, while inadequate control power can result in a failed design. Having, therefore, a framework for analyzing performance and to properly model and size the control power is essential for optimizing the flight vehicle configuration. Thus, the designer's goal when sizing and placing, engines, jets, thrusters or control surfaces is to provide sufficient, yet not excessive, control power to meet controllability and maneuvering performance specifications.

The present invention provides a useful tool for trimming effector positions to balance the forces and moments on a conceptual flight vehicle by calculating effector angles along a trajectory, and for evaluating flight vehicle performance in terms of critical performance parameters by optimally combining engine thrusts, surface rotations, thrust vectoring and reaction jets and determines if a design has enough control authority, stability and maneuverability to fly the vehicle concept in the specified trajectory environment. In one embodiment, the present invention provides these functions in interactive tools for visually evaluating vehicle maneuverability by means of vector diagrams at selected flight conditions, such as for example during wind shear. Contour plots may also be generated for visualizing vehicle stability and controllability over the entire Mach-versus-alpha envelope. The present invention may also include utilities for plotting and comparing various trajectories and performance parameters over time. Options may further be included for generating dynamic models and effector mixing matrices at selected flight conditions along the trajectory.

As noted above, the present invention is applicable to any type of flight vehicle design, including for multiple types of atmospheric vehicle configurations with blended features, such as for example missiles, launch vehicles, aircraft, rockets, or re-entry vehicles, and is capable of modeling performance under adverse situations such as an engine loss, shifts in center of gravity, sudden changes in wind conditions, and other variations in design parameters. Various types of flight vehicles may be analyzed to evaluate performance, evaluate parameter dispersions, perform disturbance analysis, and determine effector types, location, and sizing.

Flight vehicle effectors are optimally combined as a system, based on their individual capabilities in the controlled directions (three moments for roll, pitch, and yaw, and three forces represented by Fx, Fy, Fz). Stability and performance criteria are evaluated based on the combined effector system and not separately, and so the criteria are affected by the effector combination logic, which is calculated to optimize controllability.

The present invention is, in another embodiment thereof, a utility software product, embodied in a program executable by one on or more instructions and/or in a plurality of data processing modules using at least one computer processor, to provide an early-stage evaluation framework that ingests flight data and prepares a set of output data that enables broader flight vehicle performance evaluation. This is accomplished, as noted above, by modeling aerodynamic data, trajectory, propulsion, and vehicular mass properties data to assess whether a conceptual flight vehicle possesses adequate control power and maneuverability qualities to satisfy the requirements defined along the entire trajectory.

Other features and advantages of the present invention will become more apparent from the following description of the embodiments, taken together with the accompanying drawings, which illustrate, by way of example, the principles of the invention.

### BRIEF DESCRIPTION OF THE SEVERAL VIEWS OF THE DRAWINGS

FIG. 1 is a block diagram of a conceptual flight vehicle evaluation framework according to the present invention;

FIG. 2 is a block diagram of phases of flight vehicle modeling incorporating a conceptual flight vehicle evaluation framework of the present invention; and

FIG. 3 is a block diagram of a flight control loop that includes various components of a conceptual flight vehicle evaluation framework of the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

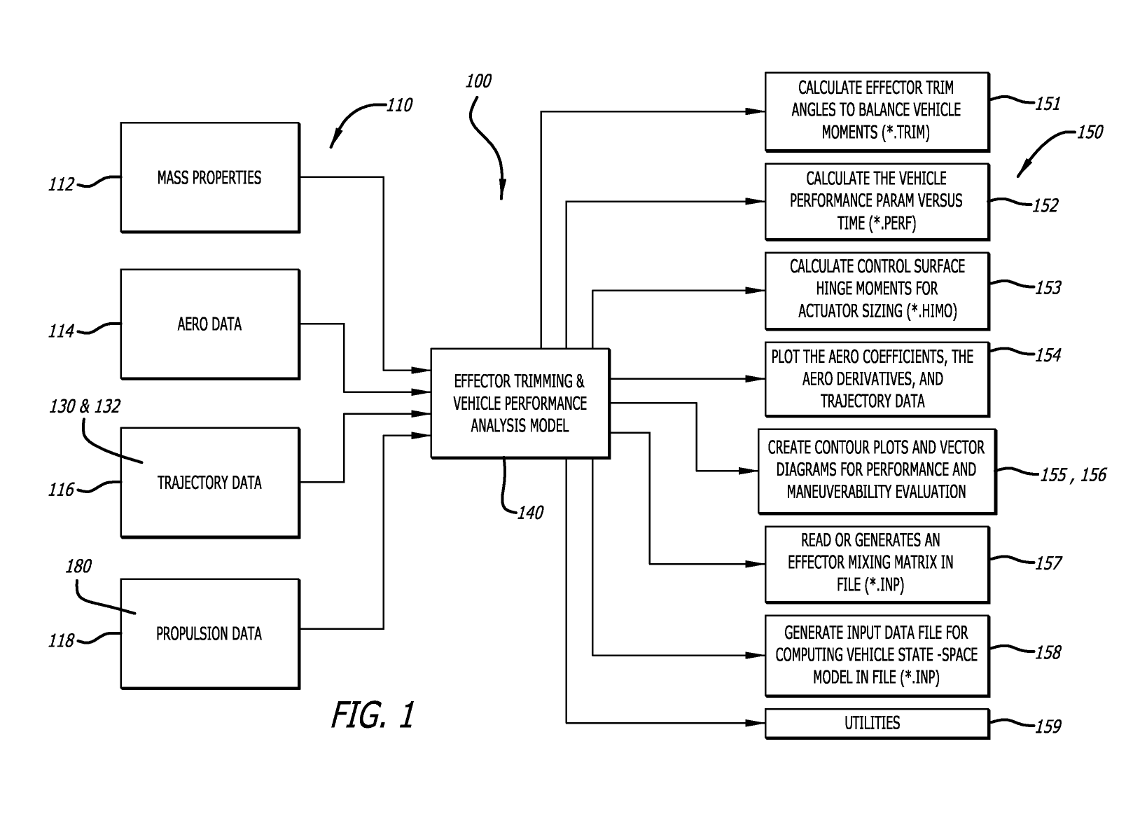

FIG. 1 is a block diagram of a conceptual flight vehicle evaluation framework 100, showing components of controls-based design and analysis of new flight vehicle conceptual designs. The conceptual flight vehicle evaluation framework 100 is an iterative process in which input data 110 for a conceptual flight vehicle 120 is collected, processed, and modified by a plurality of data processing modules to model viability of an optimal air frame configuration for a specified trajectory environment 130, prior to any further and subsequent dynamic modeling and control system design. This input data 110 may include several different vehicular characteristics for assessing whether a conceptual flight vehicle 120 possesses the capability to trim, and adequate stability, controllability, and maneuverability at critical flight conditions in a static analysis along a trajectory path 132 in the specified trajectory environment 130 to predict the dynamic behavior of the flight vehicle concept 120 and the overall effectiveness of the actuation system.

These vehicular characteristics in the input data 110 may include vehicle mass properties 112, such as for example, but not limited to, weight, inertia, and center of mass as a function of vehicle weight.

The input data 110 may also include aero data 114 that is at least comprised of aerodynamic coefficients, such as for example those relating to the base body forming the air frame configuration, damping coefficients, control aero surface increment coefficients, aero coefficient uncertainties, and hinge moments coefficients. The control surface coefficients file may optionally include surface mass properties and hinge locations for further dynamic modeling. The damping coefficients, hinge moments, and aero-uncertainties files are also optional. In the absence of these files or data the program will not be able to perform the corresponding functions.

The input data 110 may further comprise trajectory data 116 that defines the trajectory 132 within the trajectory environment 130, in parameters that at least include angle of attack (represented by a), angle of sideslip (represented by ( ) velocity, acceleration, Mach number, and dynamic pressure values. The parameters making up the trajectory data 116 further define a mission and the environment that the conceptual flight vehicle 120 endures during operation.

The input data 110 may also include propulsion-specific data 118, at least comprised of parameters that at least define the engine mass properties, reaction control jets, thrusts, thrust directions, mounting angles, thruster locations, maximum gimbaling angles, and a throttle parameter defining the amount of thrust variation from nominal, some of these parameters are optional.

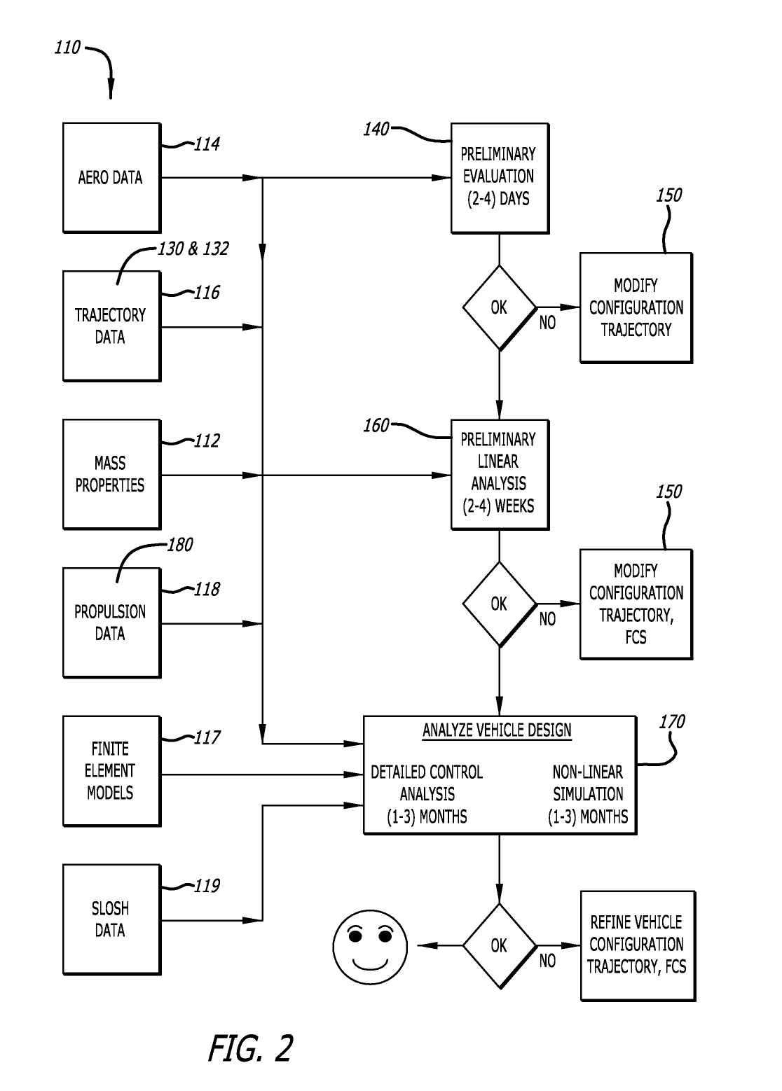

Finite element models 117 and fuel sloshing data 119 (see FIG. 2) may also be included where the conceptual flight vehicle evaluation framework is configured to generate, as a component of output data, one or more inputs for subsequent dynamic analytics and modeling.

The plurality of data processing modules together form an effector trimming and vehicle performance analysis model 140, which accepts the input data 110 and generates a plurality of output data 150 as further described herein. The conceptual flight vehicle evaluation framework 100 is configured within a computing environment that includes multiple software and hardware components configured to interactively execute program instructions in the one or more data processing modules to perform the functions of the effector trimming and vehicle performance analysis model 140, as further described herein.

It should be noted that the conceptual flight vehicle evaluation framework 100 of the present invention is a preliminary analytic phase of vehicular design, in which flight control system modeling and configuration is not yet at issue. FIG. 2 is a block diagram of phases of flight vehicle modeling incorporating the conceptual flight vehicle evaluation framework 100. This preliminary analytic phase (the conceptual flight vehicle evaluation framework 100) seeks to determine if the conceptual flight vehicle 120 is capable of being controlled, and generates, as one example of output data, an output data file configured for dynamic analysis in later phases of flight vehicle design, such as a preliminary linear analysis phase 160, and a detailed control analysis and non-linear simulation phase 170. The static analyses of the preliminary phase inform dynamic behavior and maneuverability modeling, and enable subsequent control system design that meets additional specifications, in those later phases 160 and 170. The present invention therefore provides the ability to converge to a controllable air frame configuration for a conceptual flight vehicle 120 under static design considerations prior to performing dynamic analyses and control system simulations.

The present invention therefore provides a tool for a rapid, early-phase performance evaluation of a conceptual flight vehicles 120 prior to any flight control system analysis or dynamic simulation. The conceptual flight vehicle evaluation framework 100 performs a static analysis by modeling performance parameters to enable a prediction of the dynamic behavior of the conceptual flight vehicle 120, and to generate corrective recommendations early in the design phase in a modified trajectory 132 to avoid areas of poor performance, and adjustment to flight vehicle effectors 180 to trim conditions of the flight vehicle effectors 180 along the trajectory 132.

The conceptual flight vehicle evaluation framework 100 also generates output data 150 that may be used for subsequent design phases in which preliminary rigid-body dynamic analyses of the conceptual flight vehicle 120 are performed at selected critical flight conditions by generating state-space models. The present invention therefore provides the first, preliminary phase of a multi-phase design process, the second phase (also referred to as the preliminary linear analysis 160) of which involves design of a preliminary control system, as well as modeling of linear stability and robustness. In a third phase (also referred to as a detailed control-element analysis and non-linear simulation phase 170, structural flexibility defined by finite models 117 and other dynamic modeling effects, such as tail-wag-dog, fuel sloshing 119, and other non-linearities may be included in the vehicle dynamic analysis. As noted, this third phase involves detailed stability analysis and simulations, performed for fine-tuning the control system design.

Referring back to FIG. 1, the block diagram therein shows inputs and outputs in this first, preliminary analytic phase of the process of designing a conceptual flight vehicle 120. Trimming is the process of adjusting the flight vehicle effectors 180 in order to balance the moments and forces, as described further herein. The conceptual flight vehicle evaluation framework 100 operates by modeling the various types of input data 110 to adjust, or trim, the vehicle effectors 180 as needed, in order to balance the moments and forces (comprised of the three roll, pitch and yaw moments and some or all of the three forces in the x, y and z directions (Fx, Fy, Fz)) acting on the flight vehicle 120, as the effectors 180 angularly rotate or vary their thrust thereby producing control moments and forces which counteract the aerodynamic moments and forces on the conceptual flight vehicle 120. This process of adjusting flight vehicle effectors 180 is known as “trimming” and the present invention may therefore be considered, in an additional embodiment, a framework for trimming multiple types of effectors 180. Such multi-effector trimming of the present invention occurs in an iterative process optimized to take into consideration the capability of each effector to act in a particular direction.

The process of adjusting, or trimming, in the conceptual flight vehicle evaluation framework 100 also includes the performance of several other functions in the effector trimming and vehicle performance analysis model 140. These are essential for preliminary analysis of conceptual flight vehicles 120, and they generate output data 150 in a variety of forms through a plurality of data processing modules configured to produce such output data 150. One such function is, generally, to evaluate the overall quality of the air frame configuration to meet design specifications. This includes calculating the effector trim angles 151 to balance moments and forces acting on conceptual flight vehicle 120. Many other types of calculations are also performed, including calculating vehicle performance parameters 152 versus time, and calculating control surface hinge moments 153 for actuator sizing.

The present invention may also generate various plots for graphical display, such as plots 154 of the calculated vehicle performance parameters 152 (such as for example the aero data 112, mass properties 114, and trajectory data 116) versus time. The output data modules generating these plots 154 also provide the capability to graphically modify some of the input parameters 152 to re-evaluate conceptual flight vehicle 120 performance in a modified trajectory 132.

Also, those and other performance parameters 152 (such as for example pitch and lateral stability) may be graphically displayed in additional representations of calculated output data 150, such as in contour plots 155 and vector diagrams 156 that provide a wider view of performance of a conceptual flight vehicle 120 to help locate undesirable flight conditions. Different types of vector diagrams 156 may be useful in visualizing vehicle maneuverability, effector decoupling properties, and control authority against aero disturbances in various directions, including translations.

Additionally, the conceptual flight vehicle evaluation framework 100 may be configured to generate, as another set of output data 150, an effector mixing logic matrix 157, which provides an efficient method of combining effector deflections in response to demands from a flight control system, for subsequent design phases. The effector mixing matrix 157 provides an open-loop decoupling between the control axes and consequently optimizes control authority in the directions commanded by flight control systems.

The present invention also creates dynamic models for control analysis at critical points along the trajectory 132, such as state-space models 158. The present invention enables the user to select analysis points, and the conceptual flight vehicle evaluation framework 100 generates the input data for the subsequent state-space models 158 at those selected points for further analysis.

Furthermore, the present invention may be configured to provide additional data visualization utilities 159 for plotting effector trimming positions, performance parameters and trajectory overlays and rendering those on a graphical user interface. These utilities 159 may provide users with the ability to graphically reshape angles or thrusts of some effectors 180 by constraining their deflections and, therefore, trading the deflections of some effectors 180 against others, where the conceptual flight vehicle 120 has multiple effectors 180.

Flight vehicle effectors 180 are the devices that propel and maneuver the conceptual flight vehicle 120. The effector trimming and vehicle performance analysis model 140 of the conceptual flight vehicle evaluation framework 100 analyzes at least the following four types of flight vehicle effectors 180: (1) thrust vector control (TVC) 182 effectors, which comprise engines that pivot in either two directions (pitch and yaw) or in a single (skew) direction, and which are also known gimbaling engines; (2) throttling engines 184, which are engines of varying thrust; (3) RCS, or reaction control system jets 186; and (d) control aero-surfaces 188, which rotate about a hinge. Each of these effectors 180 have specific attributes which have differing impacts on a conceptual flight vehicle 120. For example, a throttling engine 184 usually is a fixed engine that has a nominal thrust Tₑ and provides control forces on the conceptual flight vehicle 120 by varying its thrust around the nominal Tₑ. The amount of thrust variation above and below the nominal value is defined by a throttle parameter, and is adjusted in the present invention by a throttle control input which varies between −1 to +1.

The conceptual flight vehicle evaluation framework 100 models the input data 110 to adjust effector positions to balance the aerodynamic moments and forces produced on the base body of the conceptual flight vehicle 120 while attempting to fly along a pre-defined trajectory 132 with control moments and forces produced by the various vehicle effectors 180 from the gimbaling engines 182, throttling engines 184, RCS jets 186, and control aero surfaces 188 noted above. A trajectory path 132, as suggested above, is defined as a function of time by several flight parameters, including altitude, dynamic pressure, angle of attack (α), angle of sideslip (β), velocity, vehicle mass, Mach number, acceleration, thrust, etc. The trajectory 132 captures the proposed flight environment and maneuvering requirements of the conceptual flight vehicle 120. The primary concern of the flight control analyst is to make sure that the conceptual flight vehicle 120 has the effector control authority to fly along the required trajectory 132, and that the vehicle stability (or instability) is acceptable, in both a static and dynamic sense. Controllability and maneuverability is concerned with having the control capability to produce sufficient accelerations and to oppose steady-state disturbances. Static stability measures the degree by which the conceptual flight vehicle 120 turns or points towards the wind or departs turns away from the wind.

As noted above, the aerodynamic moments and forces acting on the conceptual flight vehicle 120 should be balanced with the control moments and forces generated by the control aero surfaces 188 and other effectors 180. For example, gimbaling 182 or throttling 184 flight vehicle effectors 180 must have the control authority to balance the vehicle moments at required angles of attack and sideslip specified in the trajectory data 116 defining trajectory 132, and must also have some deflection space remaining for other functions. If the effectors 180 do not have the control authority required to trim, then either the trajectory 132 has to be modified, or the vehicle aerodynamics, or the effectors, or all of the above, until a satisfactory trimming condition can be achieved. As a guideline, the control authority required for trimming the conceptual flight vehicle 120 should not exceed half of the maximum control capability of each effector 180. The designer should also reserve some control for maneuvering the conceptual flight vehicle 120 and also for reacting against disturbances, such as wind gusts.

Therefore, while balancing the vehicle moments is one of the main objectives of the present invention when modeling performance of conceptual flight vehicles 120 along the trajectory 132, the present invention may also take into account that a conceptual flight vehicle 120 should possess the control authority to balance some linear accelerations, mainly in the x- and z-directions (Aₓ and A_{z}). These are discussed in detail further herein. Furthermore, in addition to balancing, the effector trimming and vehicle performance analysis model 140 is also useful for defining the size of the gimbaling engines 182, the throttling engines 184, the RCS jets 186, and the control aero-surfaces 188. The present invention may also be used to determine the installation angles for engines or the zero positions of aero-surfaces.

In one embodiment of the present invention, the conceptual flight vehicle evaluation framework 100 calculates effector trim angles 151 along a pre-defined trajectory 132 based on pseudo-inversion of a matrix to allocate a control authority to effectors 180 based on their individual control capability in specific directions. Effector angles 151 are calculated as a function of time at each trajectory 132 point. For a stable flight along the trajectory 132, the moments and forces applied to the conceptual flight vehicle 120 due to parameters such as aerodynamics, angles of attack, sideslip, and mass should generate the accelerations which are defined in the trajectory 132. Otherwise, the propulsion 118 or the aero-surface parameters must be adjusted in order to provide the additional control moments and forces required for balancing. The conceptual flight vehicle evaluation framework 100 therefore attempts to adjust the aero surfaces, TVC angles, and thrusts of the various effectors 180 as needed in order to balance the aerodynamic and control forces and moments on the conceptual flight vehicle 120 required to match the angular and linear accelerations defined in the trajectory 132. This is accomplished by extracting rotational and translational accelerations defined in the trajectory data 116, and multiplying those values by mass and inertia. At each point along the trajectory 132, the aerodynamic and control moments and forces must produce the rotational and translational accelerations defined in the trajectory data.

Once this has been accomplished, the present invention then seeks to separate the vehicular base forces from the control forces, since the base forces cannot be modified by the effectors 180.

The base forces are those aerodynamic forces produced by the angles of attack and sideslip, and also include the moments and forces due to the un-deflected engines at nominal thrust acting on the base body, forming the air frame configuration. However, in the present invention, the only moments and forces that can be adjusted are those contributed by the effectors 180. The effectors 180 must have sufficient control authority to balance the base forces, and must have additional control authority to maneuver the conceptual flight vehicle 120 and to overcome unexpected disturbances, such as for example wind gusts. In a typical trajectory 132, the angular accelerations in the trajectory 132 are zero because it assumes that the vehicle moments are perfectly balanced, and the effector trimming becomes a zeroing of the moments noted above. When rotational accelerations are available, however, they can be used to provide a more accurate trimming capability.

The rotational accelerations from the trajectory 132 are multiplied by the vehicular moments of inertia to calculate the total vehicle inertial moments in roll, pitch, and yaw directions. Similarly, the translational accelerations from the trajectory 132 are multiplied by the vehicle mass to calculate the total force on the conceptual flight vehicle 120 along x, y, and z axes. In the present invention, the aerodynamic moments and forces must be balanced by the control moments and forces generated by the flight vehicle effectors 180. The linear accelerations (Aₓ and A_{z}) in a typical trajectory are not zero, and in some cases the conceptual flight vehicle 120 must be able to match the desired linear accelerations for maneuverability purposes since the axial acceleration affects the range and the normal acceleration affects the altitude.

The present invention models the performance of a conceptual flight vehicle 120 utilizing as many effectors 180 as there are available. The number of effectors 180 must be greater than or equal to the number of degrees of freedom that need to be balanced. All directions to be trimmed, and hence controlled, should be accessible by at least one effector 180. The more effectors 180 available, the better the controllability, because they can be combined more efficiently to effect specific directions. The conceptual flight vehicle evaluation framework 100 uses a pseudo-inverse approach that favors effectors 180 that have bigger control authority by demanding larger deflections or thrust variations from them than from the effectors 180 having reduced control capability.

The orientation of an engine among the flight vehicle effectors 180 with respect to the conceptual flight vehicle 120 is also defined in in the input data 110. It can either be at fixed angles or it can be gimbaled in the pitch and yaw directions (with respect to a fixed position) to provide thrust vectored control (TVC), and therefore, the control moments and forces produced by each effector 180 may comprise two parts: a fixed part, and an adjustable part. Thrust can either be constant or it can be modulated to provide throttle control, or it can perform both gimbaling and throttling simultaneously. Aircraft engines, for example, are modeled as throttling engines having a nominal thrust, plus or minus a certain amount of thrust variation that is defined by the throttle control input. Reaction control surface jets 186 are mounted at fixed pitch and yaw angles relative to the conceptual flight vehicle 120 and may also be considered to be throttling engines 184, with thrust capable of varying continuously between zero and ±Tₘₐₓ. In the present invention, RCS jets 186 are not considered to be “on/off” devices, but instead as continuous (analog) thrusters, so that negative thrusting is permitted. A single thruster can be used to model a pair of back-to-back firing RCS jets 186 producing positive or negative forces as a function of the throttle control input. RCS modeling in the present invention is performed for sizing the jets 186 and not for a closed-loop dynamic simulations. It should be noted that not all control aero-surfaces have to be adjustable for trimming in the present invention, and some may be defined in advance as fixed for steady and non-adjustable trimming.

The moments and forces acting on a conceptual flight vehicle 120 are comprised of two parts: the aerodynamic moments and forces resolved along vehicular body axes assuming that control effectors are at zero position, and the control moments and forces due to effector deflections. The base, aerodynamic moments and forces consist of those created by the aerodynamic environment and those created by the propulsion system when the control effectors are at zero. The aerodynamic moments and forces are defined by six basic aero coefficients, comprised of three moments and three force coefficients, and these are non-linear functions of Mach number (m), the angles of attack (α), and the sideslip (β).

As noted above, effectors 180 generate additional control forces and moments required to balance the forces and moments on the conceptual flight vehicle concept 120. For control aero surfaces 188, these are a function of various control surface increment coefficients, which are non-linear functions of the surface deflection (δₐₛᵢ), from its zero position well as of the angles of attack and sideslip (α and β) and the Mach number (m), for example, Cₘ(α, β, δₐₛᵢ, m).

For convenience of solving the numerical equations, the conceptual flight vehicle evaluation framework 100 separates the moment/force increment analysis for each control aero surface 188 into two parts: (a) a steady-state part M_{SOi}, representing the moments and forces due to the nominal surface deflection (Δ_{S0i}) from zero, that is, the moment due to the nominal aero-surface deflection (in addition to the base aero forces and moments), and (b) a linear part due to an additional small incremental deflection δₐₛᵢ relative to the nominal deflection Δ_{S0i}. For further convenience that will be discussed later the conceptual flight vehicle evaluation framework 100 normalizes the linear part by multiplying its coefficient with the max surface deflection (δ_{asiMax}). This normalizes the small deflection input (δₐₛᵢ/δ_{asiMax}) so that it becomes non-dimensional and is allowed to vary between zero and ±1.

$${M}_{Si} = {M}_{S 0 i} + [ {DM}_{si} ] ( {δ}_{asi} \text{/} {δ}_{{asi}_{MAX}} )$$

The effector moments and forces generated by a single gimbaling engine 182 are non-linear functions of the pitch and yaw deflection angles, and they also depend on a thrust variation from a nominal value. The present invention linearizes the analysis of an engine moments and forces by separating it in into three parts: (a) the nominal thrust moments and forces generated at nominal thrust T₀ᵢ and at fixed deflections (D_{zi} and D_{Yi}) corresponding to the engine mounting angles; (b) the moment and force increments generated due to small engine deflections in pitch and yaw (δ_{yei}, δ_{zei}) relative to the mounting positions; and (c) the additional moments and forces increments on the vehicle due to variation D_{Thr(i)} in engine thrust from its nominal value.

Throttling and gimbaling engine moments may be separated into three terms: (a) a steady moments and forces term M_{E0(i)} generated due to nominal thrust T₀ᵢ and at fixed deflections (D_{Zi} and D_{Yi}) corresponding to the engine mounting positions; (b) linearized moment and force increments generated due to small engine deflections in pitch and yaw (δ_{yei}, δ_{zei}) relative to engine mounting positions; and (c) an additional linearized moments and forces increment term due to the variation D_{Thr(i)} in engine thrust from its nominal value. The second linear term is normalized by multiplying its coefficients by the max pitch and yaw engine deflections capability (δ_{YMAX(i)} and δ_{ZMAX(i)}) and this normalization makes the deflection inputs to vary between zero and ±1. The throttle control input Dₜₕᵣ₍ᵢ₎ relates to thrust variations of an engine (i) 184. The throttle control input Dₜₕᵣ₍ᵢ₎ can be made to vary between zero and ±1 maximum. The actual engine thrust is defined as T₍ᵢ₎=T₀₍ᵢ₎{1+Dₜₕᵣ₍ᵢ₎} where T₀₍ᵢ₎ is the nominal engine thrust, and this means that the engine thrust can be varied between zero and 2T₀₍ᵢ₎. However, the max throttling capability parameter D_{thrMax(i)} of a throttling engine 184 is typically defined smaller than |1|. Typically |D_{thrMax}|=0.3, which means that the engine thrust may be allowed to vary ±30% from nominal. The present invention also normalizes the throttle control input by multiplying its coefficient with the throttle parameter D_{thrMax(i)}, so that the normalized throttle input varies between zero and ±1 like the other effectors. This normalization of the control inputs helps allocate the controls evenly among the effectors 180 by taking into consideration their max control capabilities in the conceptual flight vehicle evaluation framework 100.

$${M}_{E ( i )} = {M}_{EO ( i )} + [ {DM}_{E ( i )} ] \{ \begin{matrix}{δ}_{Y ( i )} \text{/} {δ}_{YMAX ( i )} \\ {δ}_{Z ( i )} \text{/} {δ}_{ZMAX ( i )}\end{matrix} \} + [ {DM}_{T ( i )} ] \{ \frac{{D}_{Thr ( i )}}{{D}_{ThrMax ( i )}} \}$$

The conceptual flight vehicle evaluation framework 100 solves for the control effector deflections and/or thrust variations which are needed to balance the base moments and forces. Because the equations are non-linear, they are solved numerically at each trajectory point by linearizing them at fixed values of (α, β, δₐₛᵢ, m), for each control aero surface 188, and using the control surface derivatives (Cₘ δₐₛᵢ) etc., which are also functions of values (α, β, δₐₛᵢ, m). Also by linearizing the thruster equations with respect to the instantaneous engine deflection angles at each trajectory point.

From above analyses of formulating the moments and forces for each separate effector, i.e. TVC/gimbaling engines 182, throttling engines 184, reaction control jets 186, and control aero-surfaces 188 acting on the conceptual flight vehicle 120, the present invention then combines all the effectors together in a single moment/force balance equation as follows. This equation is non-linear and is solved numerically at each point of the trajectory 132.

$$M ( basic ) + {\sum }_{i = 1}^{Neng} {M}_{EOi} + {\sum }_{i = 1}^{Nsurf} {M}_{SOi} + M ( disturb ) - {M}_{V} * acceleration = - M ( residual ) = - δ M ( aero surface ) - δ M ( gimbaling ) - δ M ( throttling )$$

The first term on the left hand side of this equation represents the aerodynamic moments and forces on the basic flight vehicle 120 due to its orientation (α & β angles) relative to the air flow. The next two terms are the moments and forces due to the effectors. That is, the gimbaling engines 182, throttling engines 184, and the control aero-surfaces 188 at their nominal positions. The fourth term on the left hand side is a user-defined value for external disturbance for evaluating the vehicle controllability and robustness against external disturbances. The next term is a mass-times-acceleration term as defined in the trajectory 132. If the conceptual flight vehicle 120 were able to trim perfectly without requiring any effector assistance, these forces and torques should match the (M*acceleration) term on the left side of the equation without any additional help from the control terms (δ_{M}) shown on the right hand side of equation. But this is rarely the case. The (δ_{M}) terms are due to three types of normalized control effectors: (a) control aero surface 188 deflections (δₐₛᵢ) from their trim positions from previous iterations (Δ_{SOi}), (b) pitch and yaw TVC engine 182 deflections (δyei, δzei) from their trim angles from previous iterations (D_{Yei}, D_{Zei}), and (c) additional moments and forces due to engine thrust variations (Dₜₕᵣᵢ) from their thrust T₀ᵢ in throttling engines 184. If the moments and forces do not balance with the M*acceleration terms on the left side of the equation, the present invention solves for the (δ_{M}) terms to calculate how much additional control moments and forces (due to effector deflections or thrust variations) are needed in order to balance it. The normalized unknown effector increments (right side of the above equation) are stacked together in a single vector. The following matrix equation shapes the above equation:

$$M ( resid ) = [ {DM}_{S 1} {DM}_{S 2} \vert {DM}_{E 1} {DM}_{E 2} \vert {DM}_{T 1} {DM}_{T 2} ] [ \begin{matrix}{δ}_{as 1} \text{/} {δ}_{as 1 Max} \\ {δ}_{as 2} \text{/} {δ}_{as 2 Max} \\ \text{- - - -} \\ {δ}_{y 1} \text{/} {δ}_{y 1 Max} \\ {δ}_{z 1} \text{/} {δ}_{z 1 Max} \\ {δ}_{y 2} \text{/} {δ}_{y 2 Max} \\ {δ}_{z 2} \text{/} {δ}_{z 2 Max} \\ \text{- - - -} \\ {D}_{Thr 1} \text{/} {D}_{Thr 1 Max} \\ {D}_{Thr 2} \text{/} {D}_{Thr 2 Max}\end{matrix} ]$$

$${In}_{—} {Matrix}_{—} Form \text{:} M ( resid ) = [ DM ] ( \frac{{δ}_{T}}{{δ}_{MAX}} )$$

This matrix can be solved for the effector trim positions vector (δ_{T}), which is needed to balance the residual forces and moments M_{(resid)}, with the assumption that the matrix [DM] is pseudo-invertible. This happens when the rank of [DM] is greater than or equal to the number of vehicle direction degrees of freedom to be analyzed. The normalized deflections obtained by the pseudo-inversion are multiplied by the max deflections to scale the matrix DM appropriately. This scaling allows the effectors 180 that have greater control authority in certain directions to be used more than others that are less capable in those directions.

The present invention then numerically solves for the effector trim positions vector (δ_{T}) at each point of the trajectory 132 as follows. Starting with the first trajectory time point at T=T(0), the control aero surface 188 positions are initialized at zero or biased positions (d_{S0i}), the engines 182 and 184 are initialized at the nominal pitch and yaw mounting angles (D_{Yeoi}, D_{Zeoi}), and at their nominal thrusts To(i). From the Mach number, the angles of attack and sideslip, and the engine cant angles, the present invention calculates the initial matrix [DM]₀, and the residual moment/force vector M_{0(resid)}. Using a pseudo-inverse approach, the present invention then solves for the trim angle increments in a first iteration. The present invention then uses the effector angle increments and throttle values to calculate new values for the control surface deflections, engine gimbal deflections, and thrusts for the same trajectory point, and obtain new values for matrices [DM]₁ and M_{1(residual)}. The present invention then solves for the new trim variables, and repeats iterations for the same trajectory point until the trim angles converge to steady-state values.

The iterative process is repeated for the next trajectory point at T=T(1). The present invention initializes using the trim angles from the previous trajectory time point and solves for the trim angles and throttle values at the next point, and continues this process with the remaining trajectory points, all the way to T=T(n) to obtain a time history of the effector trim angles and thrust values as a function of trajectory time. Using the graphical tools and/or the graphical user interface embodiments described herein, the user monitors the residual moments/forces and determines the success of trimming at a particular configuration. If the residual moments and optionally forces are close to zero at each trajectory point 132 then the conceptual flight vehicle 120 is considered trimmable. Otherwise, the user must check if the system of effectors 180 provide sufficient control authority to trim in the demanded directions.

As demonstrated above, the conceptual flight vehicle evaluation framework 100 calculates the effector trim angles as a function of the trajectory time by adjusting the effectors 180 as needed to balance the moments and forces on the conceptual flight vehicle 120 as already described. The initial “trim” is performed by the conceptual flight vehicle evaluation framework 100 without any adjustments from the user, by taking into consideration the maximum control authority of each effector 180. In one embodiment of the present invention, this may be performed using a software-based tool via a graphical user interface, from which many different menu options are selectable. For example, further adjustments of the trim positions by the analyst may be possible when the conceptual flight vehicle 120 has multiple effectors 180 so that one may be able to trade-off the activity of some effectors 180 against others, and this may be chosen from a list of effector trimming options from one or more menu selections.

For example, the main menu of the display on a graphical user interface enables the user to perform many different functions and generate many different types of output data 150, such as selecting plotting of data 154, performing various calculations, creating mixing logic matrices 157, creating vector diagrams 156, and modifying various parameters. An exemplary list of possible menu selections includes, but is not limited to:
Plot aero coefficients, derivatives, and control surface increments
Plot trajectory parameters versus time from the trajectory file
Trim the effector deflections to balance the vehicle moments and forces
Create an effector mixing logic or a TVC matrix
State-space modeling of the flight vehicle at selected times
Performance and stability parameter plots along trajectory time
Landing and pull-up maneuverability plus internal coupling effects
Moments at the hinges of control surfaces along the trajectory time
View and modify vehicle data (CG, MRC, TVC, Surfaces) for dispersion analysis
Contour plots (Mach versus Alpha) for performance, control authority analysis
Vector diagrams for maneuverability and stability at selected flight conditions
Plot and compare previous data files (trajectory, trim, perform, hinge moment)
   Using these menu selections, the user provides instructions to initialize the trimming process in the conceptual flight vehicle evaluation framework 100. The user may select a previous trim file to initialize the algorithm by selecting the file and clicking on a menu item to effectuate the selection, or a user may start from zero deflection angles and throttle control by clicking on a menu item so that an initialization file is specifically not selected. The user may be provided with the ability to choose the directions along which to trim the conceptual flight vehicle 120. The present invention contemplates a minimum trim as being along three rotations, but translational trimming is also possible. For example, as in the example described below, in addition to the three rotations, trimming may also occur along the x-direction. This means that the conceptual flight vehicle 120 must have at least one effector 180 controlling the x axis, that is, a speed-brake or a main engine with varying thrust. Users are also able to select a graphical display of calculated data from the menu options.

When multiple flight vehicle effectors 180 are present, trimming conditions may be shaped by the user as part of the design process. As noted above, a user of the conceptual flight vehicle evaluation framework 100 may wish to trade the activity of one effector 180 against another in modeling performance of a conceptual flight vehicle 120 along a trajectory 132. There are situations where the designer may wish to favor usage of one effector 180 versus another for reasons other than performance, for example cost or fuel efficiency. In the longitudinal direction, for example, the conceptual flight vehicle 120 may have an elevon, a body-flap, a speed brake, and thrusters. It may be possible to eliminate or to reduce activity of some of these controls during the modeling process, such as for example by keeping the body-flap at a fixed position and trimming with the other effectors 180. This will occur when the conceptual flight vehicle 120 has other effectors 180 that can provide sufficient control authority to span the control directions required to trim. If the vehicle configuration has insufficient or barely sufficient effectors 180, then the number of possible adjustments will be limited.

When the trimming process is complete the present invention plots the calculated effector trim angles and engine throttle positions. It also plots the effector upper and lower limits using, for example, lines of different colors. The present invention may further permit user adjustment of the trim positions of some effectors 180 using interactive graphics and menu choices on a graphical user interface. This is performed graphically by modifying the previous trim profiles as desired and by reducing or opening the deflection limits, thus constraining or encouraging effector utilization at specific time ranges. A horizontal menu bar includes various selectable options in screens displaying plots 154 of data. For example, a graphic options menu selection may provide a pop-up or pull-down menu enabling a user to make a selection to modify a trajectory plot 154 and from there, from a list of the available vehicle effectors 180 appears in a dialog box. The user may then select from a list of effectors 180, and further may configure or modify the display shown via additional menu options on the graphical user interface. Selection of one of the possible available effectors 180 displays its trim history calculated along the trajectory 132 from the previous trim. The reshaped effector time-histories and position limits are then used as guidelines to the trim algorithm for the next trimming process. The user may perform a “re-trim” with the user-modified trim-histories to generate a new trim profile. The success of the re-trim depends on the multiplicity of the effectors, the more the better. This may require several iterations.

In a similar fashion some of the trajectory parameters may temporarily be graphically modified, prior to trimming. The graphical modification tool of the preset invention enables evaluation of the robustness of the effectors system to perform and to handle off-nominal situations, by permitting modification of trajectory parameters to obtain this temporary trajectory modification.

As noted previously, before analyzing the dynamic characteristics of a conceptual flight vehicle 120, the designer must first evaluate if the airframe configuration satisfies the required performance along a specified trajectory 132. This performance must often account for factors such as low airspeed and wind gusts, which place the greatest demands on control authority. In addition, agile maneuvers accomplished by frequent excursions into high angle-of-attack regimes and high roll performance can result in critical control power conditions, including adverse coupling effects. To achieve a successful design, it is important to assess the control power of a proposed design concept against requirements early in the conceptual stage, prior to any control analysis and simulations. The trajectory 132 defines the mission requirements and the vehicle control authority, stability and maneuverability characteristics depend on the input data 110.

The static performance of the conceptual flight vehicle 120 can be characterized in terms of some parameters which are calculated by the present invention at every point of time along the trajectory 132. The performance parameters for the conceptual flight vehicle 120 are calculated as a function of the trajectory data 116, aero data 114, aero coefficients for the control aero surfaces 188, hinge moment coefficients, mass properties 112, and propulsion data 118 (which includes both engines and RCS jets). Some of the performance parameters also depend on the control effector mixing logic which is either calculated within the present invention or it is selected by the designer.

In one embodiment, the conceptual flight vehicle evaluation framework 100 may further include effector mixing logic within the effector trimming and vehicle performance analysis model 140 that defines how flight control system demands are translated into effector deflection commands, which may also have role in the performance evaluation.

Examples of vehicle performance parameters are static stability, center of pressure, aerodynamic center, time-to-double amplitude, or short period resonances in (rad/sec), Cₘ_{_{—}}alpha, Cₙ-beta-dynamic, and parameters relating to control authority of the system of effectors 180 collectively for maneuvering a conceptual flight vehicle 120 against wind conditions such as a wind-shear. Other parameters may include the lateral control departure parameter (LCDP) (which affects roll control), inertial coupling effects between axes due to fast maneuvering, hinge moments at the control surfaces (which are needed for sizing the actuators), bank angle near landing due to cross-wind and sideslip β, and maximum accelerations along the control axes. All these parameters are calculated as a function of the flight vehicle input data 110 and they determine the overall quality of the airframe in comparison with the design requirements.

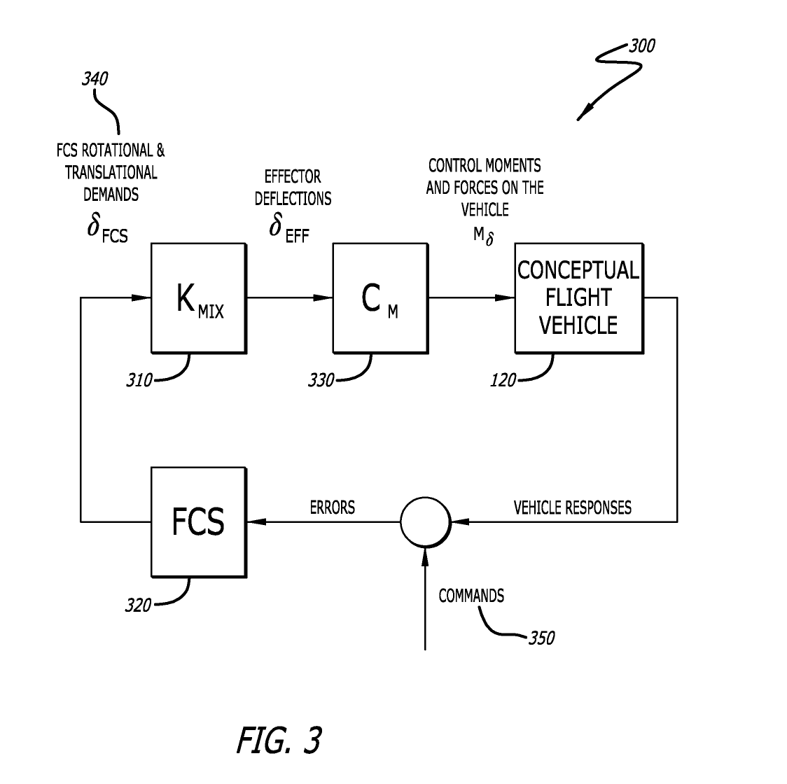

The conceptual flight vehicle evaluation framework 100 integrates the vehicle effectors 180 together in a single mixing matrix that translates the demands of the flight control system into effector commands. FIG. 3 is a block diagram of a flight control loop 300, showing a mixing logic matrix (Kₘᵢₓ) 310, the flight control system (FCS) 320, and a matrix C_{M} 330. This flight control loop 300 is an approach that generalizes the air frame configuration of the conceptual flight vehicle 120, and is not generally limited by specific types of effectors 180 that are being modeled. This is because when a conceptual flight vehicle 120 has multiple types of effectors 180 affecting many different directions, the conceptual flight vehicle 120 becomes more maneuverable and the pilot is able to rotate it and translate it in many directions.

It may be assumed that a conceptual flight vehicle 120 is controlled by multiple effectors 180 among the various types described above, such as gimbaling engines 182, throttling engines 184, RCS jets 186, and control aero-surfaces 188. The conceptual flight vehicle evaluation framework 100 determines demands 340 from the required changes in roll, pitch, and yaw deflections and linear accelerations, and from rotations and translations along x, y and z axes. The Kₘᵢₓ mixing logic matrix 310 translates these demands 340 into individual effector commands 350, such as individual control aero-surface panel rotations, engine gimbal rotations, or thrust variations. In addition to the Kₘᵢₓ mixing logic matrix 310, the present invention also relates the effector deflections to the moments and forces applied on the conceptual flight vehicle 120. This produces an output matrix C_{T} 360 (not shown) that relates the demands 340 of the flight control system 320 to the moments and forces which are applied on the conceptual flight vehicle 120.

The three moments and three forces acting on a conceptual flight vehicle 120 generated by a single engine (i) 182 that is gimbaling in the elevation (δy) and azimuth (δz) directions are given in the equation below:

$${[ \begin{matrix}{L}_{G 2} \\ {M}_{G 2} \\ {N}_{G 2} \\ {F}_{XG 2} \\ {F}_{YG 2} \\ {F}_{ZG 2}\end{matrix} ]}_{( i )} = {T}_{O} ( i ) \{ \begin{matrix}{[ \begin{matrix}0 & - {l}_{zei} & {l}_{yei} \\ {l}_{zei} & 0 & - {l}_{xei} \\ - {l}_{yei} & {l}_{xei} & 0\end{matrix} ] [ \begin{matrix}- cos ( {D}_{Z} ) sin ( {D}_{Y} ) & - cos ( {D}_{Y} ) sin ( {D}_{Z} ) \\ - sin ( {D}_{Z} ) sin ( {D}_{Y} ) & cos ( {D}_{Y} ) cos ( {D}_{Z} ) \\ - cos ( {D}_{Y} ) & 0\end{matrix} ]}_{( i )} \\ {[ \begin{matrix}- cos ( {D}_{Z} ) sin ( {D}_{Y} ) & - cos ( {D}_{Y} ) sin ( {D}_{Z} ) \\ - sin ( {D}_{Z} ) sin ( {D}_{Y} ) & cos ( {D}_{Y} ) cos ( {D}_{Z} ) \\ - cos ( {D}_{Y} ) & 0\end{matrix} ]}_{( i )}\end{matrix} \} \{ \begin{matrix}{δ}_{Y ( i )} \\ {δ}_{Z ( i )}\end{matrix} \} = \{ {V}_{G 2 Y} {V}_{G 2 Z} \} {\{ \begin{matrix}{δ}_{Y ( i )} \\ {δ}_{Z ( i )}\end{matrix} \} \\ [ \begin{matrix}{L}_{G 2} \\ {M}_{G 2} \\ {N}_{G 2} \\ {F}_{XG 2} \\ {F}_{YG 2} \\ {F}_{ZG 2}\end{matrix} ]}_{( T )} = [ \begin{matrix}↑ & ↑ & ↑ & ↑ & ↑ & ↑ \\ {V}_{G 2 y 1} & {V}_{G 2 z 1} & {V}_{G 2 y 2} & {V}_{G 2 z 2} & {V}_{G 2 y 3} & {V}_{G 2 z 3} \\ ↓ & ↓ & ↓ & ↓ & ↓ & ↓\end{matrix} ] \{ \begin{matrix}{δ}_{Y 1} \\ {δ}_{Z 1} \\ {δ}_{Y 2} \\ {δ}_{Z 2} \\ {δ}_{Y 3} \\ {δ}_{Z 3}\end{matrix} \}$$

For engines 182 that gimbal in only one direction (γₑᵢ), the gimbaling direction (γₑᵢ) is defined by the max pitch and yaw deflections (δ_{Ymax}, δ_{Zmax}), where: γₑᵢ=tan⁻¹(δ_{Z max}/δ_{Y max}).
The moments and forces on the conceptual flight vehicle 120 generated by an engine (i) 182 that is gimbaling in this single direction (γₑᵢ), and which deflects at an angle (δγₑᵢ) along (γₑᵢ), are obtained from the following equation:

$${[ \begin{matrix}{L}_{SG} \\ {M}_{SG} \\ {N}_{SG} \\ {F}_{XSG} \\ {F}_{YSG} \\ {F}_{ZSG}\end{matrix} ]}_{( i )} = {T}_{O} ( i ) \{ \begin{matrix}{[ \begin{matrix}0 & - {l}_{zei} & {l}_{yei} \\ {l}_{zei} & 0 & - {l}_{xei} \\ - {l}_{yei} & {l}_{xei} & 0\end{matrix} ] [ \begin{matrix}- cos ( {D}_{Z} ) sin ( {D}_{Y} ) cos ( {γ}_{i} ) - cos ( {D}_{Y} ) sin ( {D}_{Z} ) sin ( {γ}_{i} ) \\ - sin ( {D}_{Z} ) sin ( {D}_{Y} ) cos ( {γ}_{i} ) + cos ( {D}_{Y} ) cos ( {D}_{Z} ) sin ( {γ}_{i} ) \\ - cos ( {D}_{Y} ) cos ( {γ}_{i} )\end{matrix} ]}_{( i )} \\ {[ \begin{matrix}- cos ( {D}_{Z} ) sin ( {D}_{Y} ) cos ( {γ}_{i} ) - cos ( {D}_{Y} ) sin ( {D}_{z} ) sin ( {γ}_{i} ) \\ - sin ( {D}_{Z} ) sin ( {D}_{Y} ) cos ( {γ}_{i} ) + cos ( {D}_{Y} ) cos ( {D}_{Z} ) sin ( {γ}_{i} ) \\ - cos ( {D}_{Y} ) cos ( {γ}_{i} )\end{matrix} ]}_{( i )}\end{matrix} \} \{ {δ}_{γ ( i )} \}$$

The total moments and forces on the vehicle generated by single engines 182 which are gimbaling in a direction (γₑᵢ) and deflecting at an angle (δγₑᵢ) can be obtained from the equation below, where V_{SGi} are the column vectors for each engine (i).

$${[ \begin{matrix}{L}_{SG} \\ {M}_{SG} \\ {N}_{SG} \\ {F}_{XSG} \\ {F}_{YSG} \\ {F}_{ZSG}\end{matrix} ]}_{( T )} = [ {V}_{SG 1} {V}_{SG 2} {V}_{SG 3} ] \{ \begin{matrix}{δ}_{γ 1} \\ {δ}_{γ 2} \\ {δ}_{γ 3}\end{matrix} \}$$

The moment and force variations on the vehicle generated by the thrust variation of a single throttling engine (i) 184 are:

$${[ \begin{matrix}{L}_{TH} \\ {M}_{TH} \\ {N}_{TH} \\ {F}_{XTH} \\ {F}_{YTH} \\ {F}_{ZTH}\end{matrix} ]}_{( i )} = {T}_{O} ( i ) \{ \begin{matrix}{[ \begin{matrix}0 & - {l}_{zei} & {l}_{yei} \\ {l}_{zei} & 0 & - {l}_{xei} \\ - {l}_{yei} & {l}_{xei} & 0\end{matrix} ] [ \begin{matrix}cos ( {D}_{Y} ) cos ( {D}_{Z} ) \\ cos ( {D}_{Y} ) sin ( {D}_{Z} ) \\ - sin ( {D}_{Y} )\end{matrix} ]}_{( i )} \\ {[ \begin{matrix}cos ( {D}_{Y} ) cos ( {D}_{Z} ) \\ cos ( {D}_{Y} ) sin ( {D}_{Z} ) \\ - sin ( {D}_{Y} )\end{matrix} ]}_{( i )}\end{matrix} \} \{ {δ}_{Thr ( i )} \}$$

where:
δ_{Thr(i)} is the throttle control that varies from 0 to ±1. The actual thrust of engine (i) T(i) is equal to To(i)*(1+δThr(i)), where To(i) is the nominal engine thrust. The moment and force variations are due to the thrust variation (Tₒ₍ᵢ₎ δ_{Thr(i)}). For a RCS jet 186 the force variation equation is the same, except that, in this case Tₒ₍ᵢ₎ represents the maximum jet thrust because it's nominal thrust is zero. The moment and force variations on the conceptual flight vehicle 120 generated by throttling engines 184 are shown below, where δ_{Thri} is the throttle control of engine (i) and V_{THi} are column vectors for engine (i):

$${[ \begin{matrix}{L}_{TH} \\ {M}_{TH} \\ {N}_{TH} \\ {F}_{XTH} \\ {F}_{YTH} \\ {F}_{ZTH}\end{matrix} ]}_{( T )} = [ \begin{matrix}↑ & ↑ & ↑ \\ {V}_{TH 1} & {V}_{TH 2} & {V}_{TH 3} \\ ↓ & ↓ & ↓\end{matrix} ] \{ \begin{matrix}{δ}_{Thr 1} \\ {δ}_{Thr 2} \\ {δ}_{Thr 3}\end{matrix} \}$$

Similarly, the moment and force variations from each control aero surface 188 are also calculated. The coefficients for each surface correspond to separate physical panels, and they do not represent a combination of control aero surfaces 188. An individual surface 188 often excites multiple directions, and by defining the aero coefficients for each surface 188 separately, the surfaces 188 can be combined more efficiently via a surface combination logic. The equation below shows the control moments and forces in matrix form generated by multiple surfaces 188.

$${[ \begin{matrix}{L}_{AS} \\ {M}_{AS} \\ {N}_{AS} \\ {F}_{XAS} \\ {F}_{YAS} \\ {F}_{ZAS}\end{matrix} ]}_{δ ( i )} = \overline{Q} {S}_{ref} [ \begin{matrix}{bC}_{l δ i} \\ {cC}_{m δ i} \\ {bC}_{n δ i} \\ - {C}_{A δ i} \\ {C}_{Y δ i} \\ {C}_{Z δ i}\end{matrix} ] {\{ {δ}_{asi} \} [ \begin{matrix}{L}_{AS} \\ {M}_{AS} \\ {N}_{AS} \\ {F}_{XAS} \\ {F}_{YAS} \\ {F}_{ZAS}\end{matrix} ]}_{( T )} = [ \begin{matrix}↑ & ↑ & ↑ \\ {V}_{AS 1} & {V}_{AS 2} & {V }_{AS 3} \\ ↓ & ↓ & ↓\end{matrix} ] \{ \begin{matrix}{δ}_{as 1} \\ {δ}_{as 2} \\ {δ}_{as 3}\end{matrix} \}$$

The moments and forces on the conceptual flight vehicle 120 due to all effectors 180 can then be related together. The following equations demonstrates how the total moments and forces are obtained by stacking the column vectors from each effector 180 together in matrix form. The controls are also lined up as a vector on the right side.

$${[ \begin{matrix}{L}_{X} \\ {M}_{Y} \\ {N}_{Z} \\ {F}_{X} \\ {F}_{Y} \\ {F}_{Z}\end{matrix} ]}_{( Tot )} = [ \begin{matrix}↑ & ↑ & ↑ & ↑ & ↑ & ↑ & ↑ & ↑ & ↑ & ↑ \\ {V}_{GY 1} & {V}_{GZ 1} & {V}_{GY 2} & {V}_{GZ 2} & {V}_{G γ 1} & {V}_{G γ 2} & {V}_{TH 1} & {V}_{TH 2} & {V}_{AS 1} & {V}_{AS 2} \\ ↓ & ↓ & ↓ & ↓ & ↓ & ↓ & ↓ & ↓ & ↓ & ↓\end{matrix} ] \{ \begin{matrix}{δ}_{y 1} \\ {δ}_{z 1} \\ {δ}_{y 2} \\ {δ}_{z 2} \\ {δ}_{γ 1} \\ {δ}_{γ 2} \\ {δ}_{Th 1} \\ {δ}_{Th 2} \\ {δ}_{as 1} \\ {δ}_{as 2}\end{matrix} \} \\ or \underline{{M}_{δ}} = ( {C}_{M} ) \underline{{δ}_{eff}} where {\underline{δ}}_{eff} = ( {K}_{Mix} ) {\underline{δ}}_{FCS}$$

The combined deflections (vector δ_{eff}) may include all types of effectors 180. They are obtained by multiplying the output vector of the flight control system 320 with the mixing logic matrix, Kₘᵢₓ, 310. The flight control system 320 output vector (δ_{FCS}) represents the acceleration component of demands 340. It is comprised of a minimum three rotational demands 340 (roll, pitch, and yaw) plus some optional translation demands 340 along x, y, or z axes. Some translational demands 340 in the flight control system 320 and in the effector mixing logic matrix 310 should be included only when the conceptual flight vehicle 120 has the effector authority to perform translational maneuvers along those linear directions. By multiplying out the two matrices together, the present invention generates the output matrix 360 (explained by C_{T}=C_{M} Kₘᵢₓ) that transforms the output demands (δ_{FCS}) 340 of the flight control system 320 to vehicle control moments and forces (M_{δ}). The demands (vector δ_{FCS}) 340 of the flight control system 320 consist of at least three rotations, with up to three optional translations.

By introducing this matrix multiplication, the conceptual flight vehicle evaluation framework 100 effectively replaces the conventional control aero surface notations which apply mainly to air frames having only three types of controls with a more generic terminology for a generic type of flight vehicle that uses multiple types of controls. The rotational flight vehicle controls are now the demands 340 in roll, pitch, yaw deflections (δ_{PFCS}, δ_{QFCS}, δ_{PFCS}). The linear x-acceleration control is (δ_{XFCS}) rather than throttle or speed-brake command, etc. The individual effector deflections (or thrust variations) are combined together by means of the effector mixing logic matrix 310. When the demands 340 of the flight control system 320 change in some directions, the mixing logic matrix 310 takes care of the control distribution among the effectors 180. The mixing logic matrix 310 is calculated based on the mass properties, geometry, and flight conditions. Its derivation is based on pseudo-inversion of the moments matrix.

The output matrix (C_{T}=C_{M} Kₘᵢₓ) 360 includes elements that consist of moment and force partials with respect to commands 350 of the flight control system 320. For example, the element M_{δQ} is the pitch moment partial with respect to pitch demand (_{δQFCS}) 340. The size of output matrix (C_{T}) 360 is (6×N_{dof}) where N_{dof} is the number of the controlled directions, primarily the three rotations and perhaps some translations, typically in x and z axes. Its diagonal elements, excluding the non-controllable directions, measure the overall effector capability to guide the conceptual flight vehicle 120 in the controllable directions, which are the three rotations and up to three optional translations.

The first three inputs δ_{PFCS}, δ_{QRCS}, δ_{RFCS} to the matrix equation are the three rotational demands 340 coming from the flight control system 320 for maneuvering and stabilizing the vehicle rotations. The last three inputs δ_{XFCS}, δ_{YFCS}, δ_{ZFCS} are optional translational demands 340, which can be performed indirectly by means of rotational maneuvering. The most commonly-used translation commands 350 are δ_{XFCS} and δ_{ZFCS} for controlling the axial and normal accelerations, and are used when the conceptual flight vehicle 120 has the effectors 180 required to directly command and perform translational motion along those directions. The y-direction δ_{YFCS} is not typically controlled directly by the flight control system 320.

As noted throughout, the conceptual flight vehicle evaluation framework 100 utilizes several parameters to evaluate performance of a conceptual flight vehicle 120. One such parameter is the aerodynamic center, which is defined to be the point where the partial of pitch moment with respect to angle of attack is zero. Another parameter is static margin, which is defined to be the ratio of the difference between center of gravity and aerodynamic center over vehicle length. Another parameter is the center of pressure, which is defined to be the point about which the pitch aerodynamic moment is zero. The location of the center of pressure with respect to the center of gravity determines how much surface deflection will be needed to trim the conceptual flight vehicle 320. If the center of gravity is right on the top of the center of pressure, for example, then no surface deflection is required to trim the conceptual flight vehicle 320.

The conceptual flight vehicle evaluation framework 100 also includes a time-to-double amplitude/stability parameter, which seeks to determine how close the vehicle is to longitudinal neutral stability. Neutral stability is ideal from the controls point of view because it requires a minimal amount of control effort to steer the vehicle. The following transfer function approximates the relationship between an FCS 320 pitch axis demand (δ_{QFCS}) and the vehicle angle of attack (α).

$$\frac{α ( s )}{{δ}_{{Q}_{FCS}} ( s )} = \{ \frac{{M}_{δ Q} \text{/} {I}_{YY}}{{s}^{2} + {ω}_{P}^{2}} \} where \text{:} {ω}_{P}^{2} = [ - \frac{{M}_{α}}{{I}_{YY}} ] and {M}_{α} = \overline{Q} {S}_{ref} \overline{c} {C}_{m α}$$

The moment partial M_{δQ} represents the pitch moment on the conceptual flight vehicle 320 due to a pitch demand (δ_{QFCS}) 340 from the FCS 320. The stability or instability of a conceptual flight vehicle 120 is determined by the sign of the derivative coefficient C_{mα}. When C_{mα} is negative, ω_{P2}>0, the conceptual flight vehicle 120 is statically stable and it has a short period resonance at ω_{P} (rad/sec). When C_{mα} is positive, ω_{P2}<0, the solution of the transfer function is divergent, and the air frame is open-loop unstable. The amount of static instability in an open-loop unstable vehicle is measured by the time it takes to double its amplitude or its angle of attack.

The time-to-double-amplitude requirement on a conceptual flight vehicle 120 can be determined from its actuator's speed of response (maximum rate, acceleration capability, and delays) and also the maximum deflections capability. This requirement on a conceptual flight vehicle 120 has to be greater than the time it takes for its effectors 180 to travel from zero to maximum deflection, plus some additional margin to account for any systemic delays, such as computational delays. When the conceptual flight vehicle 120 is statically stable, on the other hand, and C_{mα} is negative, static-stability is evaluated by the short-period mode frequency (ω_{P}). When evaluating the static stability or instability of a conceptual flight vehicle 120 along the trajectory time, a useful indicator parameter is to plot the inverse of time-to-double versus time when the conceptual flight vehicle 120 is unstable. In the periods where the conceptual flight vehicle 120 is stable, the parameter plots the frequency of the short period resonance with a negative sign, (−ω_{P}) in (rad/sec) along the trajectory time. This makes it easy to differentiate between stable and unstable regions along the trajectory 132 and to avoid the time-to-double from diverging towards infinity when the conceptual flight vehicle 120 fluctuates between stability and instability. The closer to zero this parameter is the better. Typically, when the stability parameter is positive the time-to-double inverse should not exceed 2.2 sec⁻¹, and when the vehicle is stable the negative parameter (−ω_{P}) should be greater than −5 (rad/sec).

Another parameter in the conceptual flight vehicle evaluation framework 100 is directional stability (C_{nβ}-dynamic). This parameter is useful for predicting directional stability at high angles of attack. The conceptual flight vehicle 120 will be directionally stable when the parameter C_{nβ}-dynamic is greater than zero. Otherwise, it may experience yaw departure and Dutch-Roll mode instability. Aircraft with C_{nβ}-dynamic greater than (0.004) deg⁻¹ tend to exhibit very little departure tendency in yaw. Yet another parameter in the conceptual flight vehicle evaluation framework 100 is lateral time-to-double amplitude/stability. When the yaw axis is unstable (which is when C_{nβ}-dynamic<0), the time-to-double sideslip (β) amplitude should typically be 0.45 seconds or greater. The lateral stability parameter is set similar to the pitch axis by plotting the time-to-double inverse when the conceptual flight vehicle 120 is directionally unstable. Otherwise, when the conceptual flight vehicle 120 is directionally stable we plot the lateral Dutch-roll frequency (the resonance (ω_{D}) when the air frame is directionally stable) with a negative sign (−ω_{D}). As a typical guideline, when the lateral stability parameter is positive, or unstable the time-to-double inverse should not exceed 2.2 sec⁻¹, and when the vehicle is stable (−ω_{D}) should not be less than −5 (rad/sec).

As noted above, the conceptual flight vehicle evaluation framework 100 evaluates the efficiency of the effectors 180 controlling the conceptual flight vehicle 120 to maneuver it in various directions, both rotational and translational. The accelerations demand vector (δ_{FCS}) 340 from the flight control system 320 consists of between three and six elements depending on the directions to be controlled. The performance of the system of effectors 180 in a certain direction is evaluated by its capability to maneuver the conceptual flight vehicle 120 in the commanded direction.

The purpose of the mixing logic matrix 310 is to provide an optimal combination of the effector deflections that will provide the required acceleration in the demanded direction that is decoupled from other directions. Rotational or translational demand 340 during a maneuver may activate several effectors 180. However, each effector 180 has a saturation limit. For a maneuver to be efficiently performed, none of the effector deflections should reach its saturation limit. The maneuverability of a conceptual flight vehicle 120 in a particular direction is evaluated by the maximum angles of attack and sideslip that can be achieved due to an FCS demand 340 in the same direction before saturating at least one of the effectors 180. It is also evaluated by the maximum accelerations that can be achieved along the controlled directions when the demand 340 is maximized.

Accordingly, the present invention must account for limits in the demands (δ_{FCS}) 340 of the flight control system 320. Effector saturation is reflected back in a signal which drives the mixing logic matrix 310, which in turn generates commands 350 to the effectors 180 which have physical limits. Therefore, the present invention translates the effector physical limits back to demand (δ_{FCS}) 340 limits, and first determines the maximum demand (δ_{FCS}_{_{—}}_{Max}) 340 that the mixing logic matrix 310 can receive in the controlled directions before it saturates at least one of the effectors 180. The mixing logic matrix (Kₘᵢₓ) 310 therefore should be distributing the control as evenly as possible among the effectors 180 so that they should all be saturating together when the demand 340 exceeds the effector capability.

The present invention normalizes the mixing logic matrix 310 to determine the demand 340 limits by dividing each row with the maximum deflection (δᵢₘₐₓ) of the corresponding effector 180, as shown in the equation below, which relates the demands (δ_{FCS}) 340 of the flight control system 32 to the normalized effector deflections (δᵢ/δᵢₘₐₓ). The normalized effector deflection outputs must have magnitudes always less than one in order to avoid hitting their limits.

$$( \begin{matrix}{δ}_{1} \text{/} {δ}_{1 Max} \\ {δ}_{2} \text{/} {δ}_{2 Max} \\ ⋮ \\ {δ}_{n} \text{/} {δ}_{nMax}\end{matrix} ) = {[ \begin{matrix}↑ & ↑ & ↑ & ↑ & ↑ & ↑ \\ {U}_{P} & {U}_{Q} & {U}_{R} & {U}_{X} & {U}_{Y} & {U}_{Z} \\ ↓ & ↓ & ↓ & ↓ & ↓ & ↓\end{matrix} ] [ \begin{matrix}{δ}_{P} \\ {δ}_{Q} \\ {δ}_{R} \\ {δ}_{X} \\ {δ}_{Y} \\ {δ}_{Z}\end{matrix} ]}_{FCS}$$

Each of the column vectors (U_{P}, U_{Q}, U_{R}, U_{X}, U_{Y}, U_{Z}) determines the normalized effector deflections vector resulting from one unit of demand 340 in the corresponding directions (δ_{PFCS}, δ_{QFCS}, δ_{RFCS}, δ_{XFCS}, δ_{YFCS}, δ_{ZFCS}). The largest element of each of these normalized vectors are (U_{Pmax}, U_{Qmax}, U_{Rmax}, U_{Xmax}, U_{Ymax}, U_{Zmax}) and they determine which effector 180 will produce the largest deflection from one unit of demand 340 of the flight control system 320 in the corresponding direction.

A conceptual flight vehicle 120 must be designed to withstand a certain amount of wind-shear, gusts and other disturbances. The aerodynamic environment is typically characterized in terms of (α) and (β) disturbances, which are introduced in simulations as gusts and wind-shear. Gusts are used in dynamic models for determining the dynamic behavior of the conceptual flight vehicle 120, whereas for static analysis, steady wind-shear is used. Wind-shear causes steady variations in wind speed and in angles of attack and sideslip, which are considered as disturbances. These (α) and (β) disturbances induce additional moments and forces applied to the conceptual flight vehicle 120, which must be counteracted by further deflections of the gimbaling engines 182, or the thrust variations in engines 184, or by the control aero surfaces 188.

The ratio of the disturbance moment per alpha divided by the control moment per control (M_{α}/M_{δ}) is a parameter typically used for evaluating controllability. Other considerations must also be evaluated, such as the maximum values of the angle of attack (or sideslip in the lateral case described below) as well as the maximum authority of the flight control system 320.

Pitch axis controllability is one way to evaluate these additional considerations. During level flight, a conceptual flight vehicle 120 should have enough control authority to be able to take a certain amount of variation while maintaining its attitude and course, and without saturating its controls. To calculate the control authority in the pitch direction against a wind-shear disturbance which causes a steady-state angle of attack (α_{ssMax}), or this max alpha may be due to steady maneuvering. In any case, the moment due to alpha must be counteracted by the effectors as they respond to a pitch FCS demand. The pitch control authority is measured by the amount of alpha that it can achieve before saturating at least one of the pitch effectors. At steady-state, the maximum angle of attack (α_{ssMax}) that can be achieved by maximizing the pitch demand (δ_{QFCS Max}) 340 of the flight control system 320 occurs when the most active effector saturates due to the pitch demand 340. For acceptable pitch axis controllability, the present invention expects the control moment to be able to exceed the disturbance moment |C_{mδQ}δ_{Q max}|>2|Cₘₐ αₘₐₓ| where a factor of 2 is introduced to allow some room for dynamic control.

If the expected amount of max-alpha (α_{ssMax}) is a requirement (known) then the pitch authority can be measured by the ratio of the amount of effort the pitch FCS expends to counteract this (α_{ssMax}) divided by the max amount of pitch FCS effort available before it saturates at least one effector. It is a measure of effort utilization.

$$Pitch Authority = ( \frac{{δ}_{{Q}_{FCS}}}{{δ}_{{QMax}_{FCS}}} ) = \vert \frac{{C}_{m α}}{{C}_{m δ Q}} \vert {U}_{QMax} {α}_{max} < 0.5$$

The magnitude of this ratio should be less than one and to be more conservative it should be less than 0.5 in order to allow some space for dynamic maneuvering. U_{QMax} is the largest element in the vector U_{Q} from above.

Note, when the conceptual flight vehicle 120 is statically unstable, the smallest control system bandwidth for achieving a minimum of 6 dB gain margin occurs when the attitude feedback gain is K_{P}=2M_{α}/M_{δQ}, assuming a PD type controller δ_{QFCS}=−Kₚθ−Kᵣ\dot{θ} With this controller gain the control system bandwidth is ω_{b}=\sqrt{M_{α}/I_{YY}}. Increasing the attitude feedback gain Kₚ and bandwidth further improves rigid-body stability margin, as well as system performance to attitude commands.

When the conceptual flight vehicle 120 is configured with multiple control effectors 180 for translational control, this control authority evaluation may be extended to directional control. The conceptual flight vehicle 120 may also have the control authority to perform linear translations in the y and z directions (or to prevent linear translations due to alpha and beta disturbances caused by unexpected winds). This capability may require some reaction control system jets 186 to provide accelerations in the y and z directions. Alternatively, where it is desired to regulate speed in the presence of winds, this may require thrust variation or speed-brake control in the x direction. The pitch control authority analysis can be extended to linear control and to determine if the combined effector authority is sufficient to provide control against alpha variations in the x or z directions.

$$\{ Z acceler authority \} = ( \frac{{δ}_{{Z}_{FCS}}}{{δ}_{{ZMAX}_{FCS}}} ) = \vert \frac{{C}_{Z α}}{{C}_{Z δ Z}} \vert {U}_{Z Max} {α}_{max} < 0.5$$

$$\{ X acceler authority \} = ( \frac{{δ}_{{X}_{FCS}}}{{δ}_{{XMAX}_{FCS}}} ) = \vert \frac{{C}_{A α}}{{C}_{X δ X}} \vert {U}_{X Max} {α}_{max} < 0.5$$

Lateral design must include enough control authority to perform steady sideslip maneuvering during turning or near landing with a cross-wind. When a conceptual flight vehicle 120 is approaching a landing with a cross-wind, the side-force creates a sideslip angle and the air frame has to bank towards the wind. For the air frame to maintain a steady angle of sideslip (β) the net side force, and the rolling and yawing moments, must be equal to zero. Both the roll and yaw controls (δ_{PFCS} and δ_{RFCS}) of the flight control system 320 are used in order to maintain a constant sideslip (β). The designer should evaluate if the effector deflections due to the demands 340 (δ_{PFCS} and δ_{RFCS}) of the flight control system 320 and the vehicle bank angle (φ) are acceptable. The amount of roll and yaw control required to achieve a constant angle of sideslip (βₛₛ) are obtained from:

$${δ}_{{P}_{FCS}} = \frac{( {L}_{β} {N}_{δ R} - {N}_{δ} {L}_{δ R} )}{( {L}_{δ R} {N}_{δ P} - {N}_{δ R} {L}_{δ P} )} {β}_{ss}$$

$${δ}_{{R}_{FCS}} = \frac{( {L}_{β} {N}_{δ P} - {N}_{δ} {L}_{δ P} )}{( {L}_{δ R} {N}_{δ P} - {N}_{δ R} {L}_{δ P} )} {β}_{ss}$$

where the partial derivatives N_{δR} and L_{δR} represent the yaw and roll moments on the vehicle due to a yaw demand (δ_{RFCS}) 340. Similarly, the partial derivatives N_{δP} and L_{δP} represent the yaw and roll moments on the conceptual flight vehicle 120 due to a roll demand (δ_{PFCS}) 340. The roll and yaw control authority is evaluated by the amount of roll and yaw effort that is needed to produce an expected maximum amount of steady state angle of sideslip βₘₐₓ:

$$\{ Roll Authority \} = ( \frac{{δ}_{{P}_{FCS}}}{{δ}_{P {Max}_{FCS}}} ) = \vert \frac{( {L}_{β} {N}_{δ R} - {N}_{δ} {L}_{δ R} )}{( {L}_{δ R} {N}_{δ P} - {N}_{δ R} {L}_{δ P} )} \vert {U}_{{P}_{Max}} {β}_{max} < 0.5$$

$$\{ Yaw Authority \} = ( \frac{{δ}_{{R}_{FCS}}}{{δ}_{R {Max}_{FCS}}} ) = \vert \frac{( {L}_{β} {N}_{δ P} - {N}_{δ} {L}_{δ P} )}{( {L}_{δ R} {N}_{δ P} - {N}_{δ R} {L}_{δ P} )} \vert {U}_{{R}_{Max}} {β}_{max} < 0.5$$

The ratios (δ_{PFCS}/δ_{PMax}) and (δ_{RFCS}/δ_{RMAX}) represent the roll and yaw control authority, and their values should allow for some dynamic control. Similarly, for the vehicle to have sufficient control authority in the lateral y direction against a steady state (βₘₐₓ) disturbance, and assuming of course that the conceptual flight vehicle 120 has RCS jets 186 to provide controllability in the y direction, the present invention extends the test for controllability in the y direction.

Other parameters which are important when the conceptual flight vehicle 120 being modeled is under constant sideslip are the side-force and the bank angle. The side-force due to a steady cross-wind from the starboard side is balanced with a gravity component by banking the air frame towards the wind at a small angle (φ), maintaining a zero side-force.

Once the solution for δ_{PFCS} and δ_{RFCS} for maintaining a steady sideslip is found, then the bank angle required for balancing the side-force is obtained. Typically, near landing the bank angle (φ) should be less than 5 degrees. Generally, it is sufficient to demonstrate that no more than 75% of the roll and yaw control authority be devoted to maintaining a steady sideslip.

The normal and lateral load parameters (Q-alpha and Q-beta) are used for evaluating the performance of a conceptual flight vehicle 120 to withstand structural loads due to the angles of attack and sideslip. These loads are increased during periods of high dynamic pressure and for this reason some conceptual flight vehicles 120 have a load-relief system which attempts to zero-out the angles of attack and sideslip. The lateral load limits range between 3,000 and 4,000 (lb-deg/ft2).

At high angles of attack, the control authority of the effectors 180 in controlling roll may sometimes be reduced or lost. In addition, at high alpha these “roll” effectors 180 may produce significant adverse yaw which may lead to a “roll-reversal” phenomenon. As a result, the air frame rolls in opposite direction to the roll command input. The lateral control departure parameter (LCDP) ratio is a good indicator of roll axis controllability. LCDP is the ratio of the lateral departure parameter (w₀₂) divided by the Dutch-roll resonance (w_{D2}). This parameter determines the susceptibility of the conceptual flight vehicle 120 to departure during high angle of attack operation, and though usually positive, it changes sign as a function of the angle of attack. Its departure from unity is an indicator of the coupling between roll and yaw. Values greater than unity are favorable in yaw but when they are too large it has a tendency to induce beta oscillations. When the LCDP ratio is close to zero the air frame response to roll commands is sluggish. When it becomes negative it causes roll reversals on the aileron control which can be catastrophic if not anticipated. The flight control system 320 should be able to detect this situation when it happens and take an appropriate action.

In a re-entry vehicle, which usually enters the atmosphere at high angles of attack, the rudder becomes ineffective and its flight control gain is phased-out. During this period the aileron is used for roll and directional control and often in combination with yaw RCS jets 186. The LCDP ratio may be negative during this period which implies roll-reversal, but this may be acceptable as long as the parameter is not too close to zero. When the angle of attack is reduced the rudder becomes more effective and the gain in the rudder control loop is increased appropriately. As the angle of attack decreases there is a period during which the LCDP magnitude becomes very small and eventually changes sign to positive. During this period the aileron becomes unreliable and ineffective for lateral control and the conceptual flight vehicle 120 has to rely fully on RCS 186 control. The relation of roll acceleration due to a roll command from the flight control system 320 can be approximated with the transfer-function below:

$$\frac{\dot{p} ( s )}{{δ}_{{P}_{FCS}} ( s )} = \frac{{L}_{{δ}_{P}}}{{I}_{XX}} \{ \frac{{s}^{2} + {ω}_{φ}^{2}}{{s}^{2} + {ω}_{D}^{2}} \} where$$

$${ω}_{φ}^{2} = \frac{cos {α}_{o}}{{I}_{ZZ} {L}_{δ p}} [ {N}_{β} {L}_{δ p} - {L}_{β} {N}_{δ p} ] and {ω}_{D}^{2} = [ \frac{{N}_{β} cos {α}_{o}}{{I}_{ZZ}} - \frac{{L}_{β} sin {α}_{o}}{{I}_{XX}} ]$$

$${N}_{β} = \overline{Q} {S}_{ref} {bC}_{n β} {L}_{β} = \overline{Q} {S}_{ref} {bC}_{l β}$$

$${N}_{δ p} = \frac{\partial {N}_{Z}}{\partial {δ}_{{P}_{FCS}}} {L}_{δ p} = \frac{\partial {L}_{X}}{\partial {δ}_{{P}_{FCS}}}$$

The partials N_{β} and L_{β} represent the yaw and roll moments on the conceptual flight vehicle 120 due to changes in the angle of sideslip (β). The partials N_{δp} and L_{δp} represent the yaw and roll moments on the conceptual flight vehicle 120 due to variations in roll demand (δ_{PFCS}) 340 from the flight control system 320 and are obtained from output matrix (C_{T}) 360. When the LCDP is equal to 1, the vehicle roll/yaw response to a roll command is ideal. It produces a perfect turn with zero sideslip angle (β). An acceptable range of LCDP is 15>|LCDP|>0.2. The LCDP ratio strongly depends in the roll/yaw effector coupling which is determined by the mixing matrix (Kₘᵢₓ) 310. To improve this value, the Kₘᵢₓ mixing logic matrix 310 can be adjusted to include the contributions of the yaw effectors at high angle of attack. This can dramatically improve the value of LCDP at high angle of attack.

When a re-entry vehicle is flying at high angles of attack with poor directional stability (the vertical stabilizer is ineffective because the wake from the wings is preventing it from operating in clean air flow), it must have an acceptable LCDP in order for the ailerons to stabilize the airframe. Negative values of the LCDP ratio are acceptable, as long as they are not close to zero. It causes, however, control reversal in roll, and the roll control system must be able to predict it and compensate for it.

When a conceptual flight vehicle 120 is transitioning from a negative LCDP to positive LCDP (occurring at low α), there is a region in the trajectory 132 where the roll controllability is also reduced to unacceptable values. The yaw control loop alone may not be able to control the conceptual flight vehicle 120 during the period of low LCDP. For the roll control loop to be robust against instability due to aerodynamic uncertainties, the magnitude of the LCDP parameter should be considerably larger than zero (either positive or negative) before the aileron is considered reliable for roll control, especially, during periods of poor rudder control.

Reaction control surface jets 186 are often used to control the conceptual flight vehicle 120 in roll and yaw during this LCDP transitioning. Both roll and yaw must be controlled, because the conceptual flight vehicle 120 is maneuvering about its velocity vector at high angles of attack. During this transitioning period the RCS torques must be sized appropriately in order to be able to overcome the uncertain aerodynamic moments and to be able to provide at least 1.5 deg/sect angular acceleration in roll and yaw.

The magnitude of the LCDP ratio should not be close to zero in order to avoid control reversals caused by uncertainties and resulting to instability. Likewise, the LCDP should not be very large because it causes large sideslip (β) transients. A turn is perfectly coordinated when the LCDP ratio is equal to (1). The vehicle roll/yaw response to a roll command is ideal generating a perfect turn with zero sideslip angle (β).

The capability of the flight vehicle effectors 180 to provide rotational acceleration about the x, y, and z axes of the conceptual flight vehicle 120 can be evaluated in terms of the largest rotational accelerations that can be achieved in the corresponding directions before saturating at least one of the effectors 180. This is based on the roll, pitch, and yaw moment equations:

$$\dot{p} = \frac{{L}_{δ P}}{{I}_{XX}} {δ}_{{P}_{FCS}} \dot{q} = \frac{{M}_{δ Q}}{{I}_{YY}} {δ}_{{Q}_{FCS}} \dot{r} = \frac{{N}_{δ R}}{{I}_{ZZ}} {δ}_{{R}_{FCS}}$$

where δ_{PFCS}, δ_{QFCS}, δ_{RFCS} are the rotational demands 340 from the flight control system 320. The demand (δ_{QFCS}) 340 corresponds to the column vector U_{Q} from mixing logic matrix 310, and the dimension of U_{Q} is equal to the number of control effectors 180. The rotational acceleration is maximized when the deflection of the most active effector 180 reaches its peak limit δᵢₘₐₓ. The maximum rotational accelerations in roll, pitch, and yaw, are solved by:

$${\dot{p}}_{Max} = \frac{{L}_{δ P}}{{I}_{XX} {U}_{P Max}} {\dot{q}}_{Max} = \frac{{M}_{δ Q}}{{I}_{YY} {U}_{Q Max}} {\dot{r}}_{Max} = \frac{{N}_{δ R}}{{I}_{ZZ} {U}_{R Max}}$$

Similarly, the capability of the control effectors 180 to perform translation maneuvers along the x, y, and z axes of the conceptual flight vehicle 120 can be evaluated in terms of the largest vehicle acceleration in a certain direction that can be achieved when at least one of the effectors 180 reaches its limit. The acceleration in a certain direction reaches its maximum value when the deflection of the most active effector reaches its maximum limit δ_{iMax}. The maximum translational accelerations along x, y, and z are:

$${\dot{u}}_{Max} = \frac{{F}_{X δ X}}{{M}_{V} {U}_{X Max}} {\dot{v}}_{Max} = \frac{{F}_{Y δ Y}}{{M}_{V} {U}_{Y Max}} {\dot{w}}_{Max} = \frac{{F}_{Z δ Z}}{{M}_{V} {U}_{Z Max}}$$

Here, U_{Xmax} is the element that has the largest magnitude in vector U_{X}. The column vector U_{X} corresponds to the demand (δ_{XFCS}) 340 and its dimension is equal to the number of control effectors 180.

The present invention may also be configured to analyze the amount of pitch command 350 of the flight control system 320 and the angle of attack required to hold a conceptual flight vehicle 120 in a steady pull-up maneuver with a load factor n_{z}. The present invention analyzes the point where the flight path tangent is horizontal when the conceptual fight vehicle 120 performs a circular pull-up maneuver at constant speed V, and hence the net normal force vertically upward is L−W=(n_{z}−1)W. The normal acceleration is therefore (nz−1)g, and the angular velocity (q) of the conceptual flight vehicle 120 is the normal acceleration divided by the constant speed. The increment in lift and moment during the pull-up maneuver due to a pitch increment command (Δδ_{QFCS}) 350 and a change in the angle of attack (Δα) is

ΔC_{L}=C_{L}_{_{α}}Δα+C_{L}_{_{q}}\hat{q}+C_{L}_{_{δQ}}Δδ_{QFCS}

ΔCₘ=Cₘ_{_{α}}Δα+Cₘ_{_{q}}\hat{q}+Cₘ_{_{δQ}}Δδ_{QFCS}=0

where:

$$Δ {C}_{L} = \frac{Δ L}{\overline{q} S} = \frac{( {n}_{z} - 1 ) w}{\overline{q} S} and \hat{q} = \frac{( {n}_{z} - 1 ) \overline{c} g}{2 {V}^{2}}$$

The present invention then solves for the change in pitch control, and the change in angle of attack:

$$[ \frac{Δ {δ}_{QFCS}}{{n}_{z} - 1} ] = - \frac{1}{D} \{ ( {C}_{{m}_{q}} \frac{g \overline{c}}{2 {V}^{2}} ) {C}_{{L}_{α}} + ( \frac{W}{\overline{q} S} - {C}_{{L}_{q}} \frac{g \overline{c}}{2 {V}^{2}} ) {C}_{{m}_{α}} \} \\ [ \frac{Δ α}{{n}_{z} - 1} ] = \frac{1}{D} \{ ( {C}_{{m}_{q}} \frac{g \overline{c}}{2 {V}^{2}} ) {C}_{{L}_{δ Q}} + ( \frac{W}{\overline{q} S} - {C}_{{L}_{q}} \frac{g \overline{c}}{2 {V}^{2}} ) {C}_{{m}_{δ Q}} \}$$

$$where \text{:} D = {C}_{L α} {C}_{{m}_{δ Q}} - {C}_{m α} {C}_{{L}_{δ Q}} and \frac{W}{\overline{q} S} = {C}_{L}$$

which is the lift coefficient at level flight.

The present invention evaluates the flight vehicle maneuverability and if it has enough control power to achieve its maximum loading specifications during a pull-up maneuver. The ratio of increment to achieve max load over max increment to saturation is then calculated, assuming a constant speed V and pitch rate q.

A conceptual flight vehicle 120 must also possess sufficient nose down pitch authority to overcome the nose up moment as a result of inertial cross-coupling during high angle of attack, stability axis, and roll maneuvers about the velocity vector V, assuming a constant flight path without sideslip. The pitching moment due to roll and yaw body rates is obtained from the following equation:

M=I_{Y}\grave{q}−I_{XZ}(r²−p²)−(I_{Z}−I_{X})rp

The roll rate in stability axis (p_{stab}), which is pure roll about the velocity vector, is a function of the body rates (p and r). The pitching moment (M_{IC}) due to inertial coupling with p_{stab} can be expressed as

M_{IC}=[I_{XZ} cos(2α)−0.5(I_{Z}−I_{X})sin(2α)]p_{stab}²

which illustrates how the induced pitching moment M_{IC} dramatically increases with roll rate (p_{stab}). This nose up moment due to roll coupling reaches its maximum at α=45°, so the conceptual flight vehicle 120 must have enough pitch control authority to overcome this coupling moment. The max roll rate must be less than:

$${p}_{stab}^{2} < \frac{{M}_{δ Q}}{[ {I}_{XZ} cos ( 2 α ) - 0.5 ( {I}_{Z} - {I}_{X} ) sin ( 2 α ) ] {U}_{Q Max}}$$

A margin factor should be allowed for, because some additional control power is needed for normal flight path control. Some pitch authority is needed only to maintain attitude at zero roll rate.

The yaw controller must possess adequate authority to overcome the yaw inertial coupling moments during a rolling pullout maneuver (which produces simultaneously roll and pitch rates). The adverse yawing moment during a rolling pullout maneuver is:

N_{IC}=(I_{X}−I_{Y})pq cos(α)

where the max pitch rate (q) is determined by the bank angle and the normal load factor applied to the air frame. The adverse yawing moment is most severe, because it results to highest pitch rate, when the loading occurs while the conceptual flight vehicle 120 is inverted (due to additional contribution from gravity). The max pitch rate (q) of the air frame while inverted at max loading is

$$q = \frac{( {n}_{z} + 1 ) g}{V}$$

and the yaw control (δ_{RFCS}) of the flight control system 320 needed to counteract this adverse yawing moment is

$${N}_{δ R} {δ}_{RFCS} = ( {I}_{Y} - {I}_{X} ) p cos ( α ) \frac{( {n}_{z} + 1 ) g}{V}$$

The max roll rate (at max pitch rate) that the yaw can handle before it saturates the yaw effectors 180:

$${p}_{max} < \frac{{VN}_{δ R}}{{U}_{R Max} ( {I}_{Y} - {I}_{X} ) cos ( α ) ( {n}_{z} + 1 ) g}$$

The moments at the hinges of the control aero surfaces 188 are used for sizing the actuator torques. Control aero surfaces 188 rotate about a hinge line which is parallel to the wings, and tails and powered by electro-mechanical or hydraulic actuators. The torque supplied by the actuator must be greater than the torques generated by the aerodynamic forces on the surface 188.

The hinge moment at a control aero surface 188 is a function of the dynamic pressure, the reference area of the surface 188, the chord which is the distance between the surface center of pressure and the hinge line, the deflection angle, and the hinge moment coefficient which varies as a function of α, β, mach number and surface deflection. For a control aero surface (i) 188 the hinge moment is obtained from:

$${M}_{HSi} = \overline{Q} {S}_{R si} {\overline{c}}_{h si} \{ {C}_{hmc} ( i , m , α , β , {δ}_{so} ) + ( \frac{\partial {C}_{hmc} ( i , m , α , β , {δ}_{so} )}{\partial {δ}_{si}} ) {\vert}_{so} \{ {δ}_{si} - {δ}_{so} \} \}$$

The hinge moment coefficients of a surface (i) 188 (C_{hmc} (i, m, α, β, δ)) are a function of four variables: the Mach number (m), the angles of attack and sideslip (α, β) and the control surface deflection (δₛᵢ). These are generated at discrete surface deflection increments (δₛₒ). The first part of the above equation calculates the hinge moment at a deflection (δₛₒ) which is the nearest to the actual surface deflection (δₛᵢ). The second term uses the hinge moment derivatives to extrapolate the hinge moment for the additional deflection difference (δₛᵢ−δₛₒ). This prevents discontinuities in the calculation of the hinge moments.

The systems and methods of the conceptual flight vehicle evaluation framework 100 may be implemented in many different computing environments. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, and any comparable means. In general, any means of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other such hardware. Some of these devices include processors (e.g., a single or multiple microprocessors), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A method of evaluating performance and control effectiveness of conceptual vehicle designs, comprising:
defining a plurality of vehicular data for assessment of whether a conceptual flight vehicle possesses adequate stability, controllability and maneuverability characteristics to perform a required mission defined by a trajectory, the plurality of vehicular data including vehicle mass properties and aero data relative to aerodynamic moments and forces acting on a base body of the conceptual flight vehicle, trajectory data defining a conceptual flight vehicle's mission-specific environment and maneuvering requirements that includes one or more angular and linear accelerations, and propulsion data relative to a plurality of flight vehicle effectors powering the conceptual flight vehicle;
modeling the plurality of vehicular data along the trajectory by performing a plurality of processing functions configured to:
assess a control capability of the plurality of flight vehicle effectors to allocate a control authority in specific directions, so that the control authority allocated for the plurality of flight vehicle effectors as a combined system is at least twice an effect of an expected amount of disturbance experienced by the conceptual flight vehicle in each direction,
calculate deflection angles and thrust variations along the trajectory for the plurality of flight vehicle effectors by applying a pseudo-inverse approach favoring flight vehicle effectors that have a larger control authority over flight vehicle effectors that have a reduced control authority along demanded directions, wherein the control authority in the demanded directions is defined by an effort required to counteract an expected amount of disturbance, and
solve for control surface deflections influencing control moments and forces acting on the conceptual flight vehicle by linearizing the control surface deflections at fixed angles for each control surface; and
modifying at least one of the trajectory data and the propulsion data until a satisfactory control authority is achieved that balances the control moments and forces produced by the plurality of flight vehicle effectors with the aerodynamic moments and forces acting on the base body, wherein a balance of the aerodynamic moments and forces and the control moments and forces generates an optimal and controllable air frame configuration design for the conceptual flight vehicle.

2. The method of claim 1, further comprising enabling a graphical modification of the vehicular data to iteratively solve for the control surface deflections at least using a modified trajectory.

3. The method of claim 1, further comprising enabling a graphical modification of one or both of the deflection angles and thrust variations of the plurality of vehicle effectors by constraining their control surface deflections.

4. The method of claim 1, wherein the conceptual flight vehicle has an atmospheric vehicle configuration selected from a group consisting of an aircraft, a missile, a launch vehicle, and a re-entry vehicle.

5. The method of claim 1, wherein the defining a plurality of vehicular data further comprises defining the vehicle mass properties to further define the base body by at least including a weight, an inertia, a center of mass as a function of vehicle weight, a vehicle geometry, and a location of one or more of vehicle sensors, engines, jets, and control surfaces.

6. The method of claim 1, wherein the defining a plurality of vehicular data further comprises defining the aero data to include aerodynamic coefficients that at least include control surface increment coefficients, damping derivatives, aero uncertainties, and hinge moments coefficients.

7. The method of claim 1, wherein the defining a plurality of vehicular data further comprises defining the trajectory data to at least include an angle of attack value, an angle of sideslip value, a velocity, an acceleration, and a dynamic pressure.

8. The method of claim 1, wherein the defining a plurality of vehicular data further comprises defining the propulsion data to at least include a throttle parameter defining an amount of thrust variation, an engine thrust size, and installation angles defining a thrust direction relative to the conceptual flight vehicle, wherein the one or more flight vehicle effectors include at least one of gimbaling engines, throttling engines of varying thrust, reaction control jets, and control aero surfaces.

9. The method of claim 1, wherein the modifying at least one of the trajectory data or the propulsion data until a satisfactory control authority is achieved further comprises adjusting one or more of the vehicle mass properties and aero data in order to allocate an effect produced by the one or more angular and linear accelerations defined in the trajectory data on the conceptual flight vehicle.

10. The method of claim 1, further comprising generating one or more of a dynamic model and an effector mixing matrix for modeling dynamic behavior of the conceptual flight vehicle at critical points along the trajectory.

11. The method of claim 1, wherein the defining a plurality of vehicular data further comprises defining an initial shape of the base body.

12. An early evaluation system for a conceptual flight vehicle, comprising:
a computer processor; and
at least one computer-readable storage medium operably coupled to the computer processor and having program instructions stored therein, the computer processor being operable to execute the program instructions to perform one or more data processing functions on input data defining a trajectory environment to evaluate a control authority of a conceptual flight vehicle and assess whether the conceptual flight vehicle possesses adequate stability, controllability and maneuverability properties at critical flight conditions along a trajectory as a function of time, the critical flight conditions at least including vehicle mass properties and aero data relative to aerodynamic moments and forces acting on a base body of the conceptual flight vehicle, trajectory data defining a conceptual flight vehicle's mission-specific environment and maneuvering requirements that includes one or more angular and linear accelerations, and propulsion data relative to a plurality of flight vehicle effectors powering the conceptual flight vehicle,
the plurality of data processing functions configured to performing a static analysis on a performance of the conceptual flight vehicle to identify a responsiveness to the stability, controllability and maneuverability properties and predict a dynamic behavior of the conceptual flight vehicle in the trajectory environment, by allocating control authority values to the plurality of flight vehicle effectors as a combined system based on control capability in specific directions so that control authority allocated is at least twice an effect of an expected amount of disturbance experienced by the conceptual flight vehicle in each direction, and adjusting one or more of aero-surface coefficients, control surface deflections, and variations in thrust of the plurality of flight vehicle effectors to balance control moments and forces acting on the conceptual flight vehicle to match an effect of angular and linear accelerations in aerodynamic moments and forces acting on a base body of the conceptual flight vehicle in the trajectory environment.

13. The system of claim 12, further comprising a set of output data generated by the computer processor and configured to enable one or more of an evaluation of an overall quality of the conceptual flight vehicle, the set of output data including one or more of a graphical plot of trajectory data versus time, a graphical modification of one or more parameters to reshape angles or thrusts of some effectors in the one or more effectors by constraining their deflections, a graphical plot of aero coefficients, creation of an effector mixing logic matrix and dynamic models enabling a control analysis at critical points along the trajectory, calculation of control moments at one or more hinges of the control surfaces based on trajectory parameters and the control surface angles, and a graphical plots of effector positions, performance parameters and trajectory time histories.

14. A method of evaluating a flight vehicle concept, comprising:
creating a plurality of input data defining a trajectory environment to evaluate a control authority of flight vehicle effectors powering a conceptual flight vehicle and assess whether the conceptual flight vehicle possesses adequate stability, controllability and maneuverability along a defined trajectory
the input data at least including vehicle mass properties, aero data relative to aerodynamic moments and forces acting on a base body of the conceptual flight vehicle, trajectory data defining a the trajectory of the conceptual flight vehicle's mission-specific environment and maneuvering requirements that includes one or more angular and linear accelerations, and propulsion data relative to the one or more flight vehicle effectors powering the conceptual flight vehicle;
performing a static analysis on a performance of the conceptual flight vehicle to identify a responsiveness to the stability, controllability and maneuverability properties and predict a dynamic behavior of the conceptual flight vehicle in the trajectory environment, by allocating control authority values to the flight vehicle effectors as a combined system based on control capability in specific directions so that the control authority allocated is at least twice an effect of an expected amount of disturbance experienced by the conceptual flight vehicle in each direction, and adjusting one or of control surface deflections and variations in thrust of the flight vehicle effectors to balance control moments and forces acting on the conceptual flight vehicle to match an effect of angular and linear accelerations in aerodynamic moments and forces acting on a base body of the conceptual flight vehicle in the trajectory environment; and
generating a set of output data defining performance parameters of the conceptual flight vehicle in the trajectory environment that enable a quality evaluation of the flight vehicle effectors coupled to the base body of the conceptual vehicle, the set of output data at least one of a dynamic model and an effector mixing matrix for evaluation of the conceptual flight vehicle at selected flight conditions.

15. The method of claim 15, wherein the flight vehicle effectors are at least one of gimbaling engines, throttling engines of varying thrust, reaction control surface jets, and control aero surfaces rotating about a hinge.

16. The method of claim 14, wherein the generating a set of output data defining performance parameters of the conceptual flight vehicle in the trajectory environment further comprises enabling performance modeling under adverse conditions that include losing an engine, shifts in center of gravity, and variances in wind conditions.

17. The method of claim 14, further comprising enabling a graphical modification of the input data to re-evaluate performance of the conceptual flight vehicle using a modified trajectory.

18. The method of claim 14, further comprising enabling a graphical modification of the deflection angles or thrust variations of the vehicle effectors by constraining their deflections.

19. The method of claim 18, wherein the effector mixing logic matrix combines effector deflections in response to demands from a flight control system and optimizes control authority in the directions commanded by the flight control system.

20. The method of claim 14, wherein the dynamic model enables linear simulations of dynamic behavior at selected flight conditions along the trajectory.
